(19) United States
(12) Patent Application Publication
(10) Pub. No.: US 2025/0330813 A1
(43) Pub. Date: Oct. 23, 2025

(54) TECHNOLOGIES FOR ISOLATING NETWORK FUNCTIONS

(71) Applicant: Intel Corporation, Santa Clara, CA (US)

(72) Inventors: Akhilesh S. THYAGATURU, Ruskin, FL (US); Jason M. HOWARD, Portland, OR (US); Gurpreet Singh KALSI, Portland, OR (US)

(21) Appl. No.: 19/255,899

(22) Filed: Jun. 30, 2025

(51) Int. Cl. H04W 12/08

(52) U.S. Cl. CPC H04W 12/08

(57) ABSTRACT

Examples described herein include shared reserved memory regions providing communications among network functions for isolation among network slices. In some examples, circuitry is configured to: based on receipt of a first request, allocate a first region of one or more memory regions of a memory to store data reserved for access by a first network function, wherein the first network function comprises an Open Radio Access Network (ORAN) Control Unit (CU) of a radio access network (RAN) and wherein an ORAN Distributed Unit (DU) is to provide the data and based on receipt of a second request, allocate a second region of one or more memory regions of the memory to store second data reserved for access by a second network function, wherein the second network function comprises a second ORAN CU of the RAN, the DU is to provide the second data, and the DU is shared among the first CU and the second CU.

### BACKGROUND

A data center may include one or more computing platforms. A computing platform can include a processor, accelerator, and associated memory modules. Computing platforms of the datacenter may facilitate the performance of processes associated with various applications running on and/or hosted by computing platform. These processes may be performed by the processors and other associated logic of the computing platforms. Each computing platform may additionally include input/output (I/O) controllers, such as network interface devices, which may be used to send and receive data on a network for use by the various applications.

3rd Generation Partnership Project (3GPP) defines a fifth-generation wireless technology (5G) in Release 15 (2018) and 3GPP defines NextG Core (5GC) in Release 16 (2020) for cellular networks to provide wireless communications between User Equipment (UE) devices and base stations. A 5G Radio Access Network (RAN) connects individual devices to other parts of a network through radio connections. 5G networks and 5GC architectures isolate services to ensure secure and tenant-aware network slicing for applications, including enterprise, industrial, and public safety networks. Network slicing allows a single physical network infrastructure (e.g., computing platform) to be divided into multiple slices of virtual and isolated networks. A slice can be tailored to specific user needs, applications, or use cases with different performance characteristics, such as, latency, reliability, and bandwidth.

The O-RAN Alliance defines specifications for Open RAN (ORAN) which disaggregate the RAN into a Distributed Unit (DU) for processing data received from a Radio Unit (RU) to prepare data for transmission to the Centralized Unit (CU).

### BRIEF DESCRIPTION OF THE DRAWINGS

FIG. 1 illustrates an example first system.

FIG. 2 illustrates example controlled shared memory (COSM) management circuitry.

FIG. 3 illustrates an example second system.

FIG. 4 illustrates an example isolation scheme.

FIG. 5 illustrates an example first permission matrix scheme.

FIG. 6 illustrates an example second permission matrix scheme.

FIG. 7 illustrates an example data transfer scheme.

FIGS. 8A-8C illustrate example in-memory compute and isolation schemes.

FIG. 9 illustrates an example operation.

FIGS. 10A-10G illustrate example event sequences.

FIGS. 11A and 11B depict example processes.

FIG. 12 depicts an example system.

### DETAILED DESCRIPTION

A network operator can own and manage a physical network infrastructure. Network operators can include telecommunication companies (telcos) that permit devices (e.g., smartphones, cell phones, tablets, personal computers, televisions, radios, or other devices) to access the Internet using wireless communications technologies (e.g., 5G or 5GC) or wired communications technologies. Multiple different network tenants can share hardware resources of the physical network infrastructure, such as processors, memory, accelerators, and other circuitry. However, sharing of resources can introduce security concerns as traffic processed by a tenant may be accessible by another tenant.

Various examples can provide for performance of network functions associated at least with O-RAN and NextG Core that communicate using a memory device with selective read and write accesses. Shared memory devices with memory segmentation between tenants can prevent a tenant from accessing data of another tenant. For example, multiple tenants can securely share memory and compute resources to perform an ORAN 5G Distributed Unit (DU) and Remote Radio Head (RRH) while maintaining memory and compute separation among tenant-specific Control Units (CUs) and 5G Core networks. Examples can provide an isolated multi-slice RAN configuration suitable for multi-tenant and critical-use scenarios such as data sovereignty and regulatory compliance. A slice can be instantiated in its own COSM-controlled memory domain, reducing the attack surface and ensuring high assurance for sensitive applications like public safety, healthcare, or defense.

As described herein, shared memory devices can be utilized to isolate network functions and data access among different network operators or tenants. Where a tenant or user request quality of service (QOS) or service level agreement (SLA) parameters, various examples described herein can allocate memory and resources (e.g., processors, accelerators, network interface devices, or others) to perform the network functions, and based on real-time telemetry, selectively modify the memory and resource allocation to meet or exceed QoS or SLA parameters. For example, based on QoS and SLA and real-time telemetry, various examples can change the allocated memory, change the allocated processor frequency or number of cores allocated to perform the network slice, change the allocated accelerator frequency or number of accelerators allocated to perform the network slice. Accordingly, various examples can perform dynamic resource reconfiguration based on real-time telemetry to adapt to changing system loads and operational priorities.

Some examples provide communications of non-secure flows that use shared memory without restricting a tenant from accessing the shared memory, such as for untrusted-O-RAN components. Trusted O-RAN and untrusted-O-RAN components can operate in physically segmented environments.

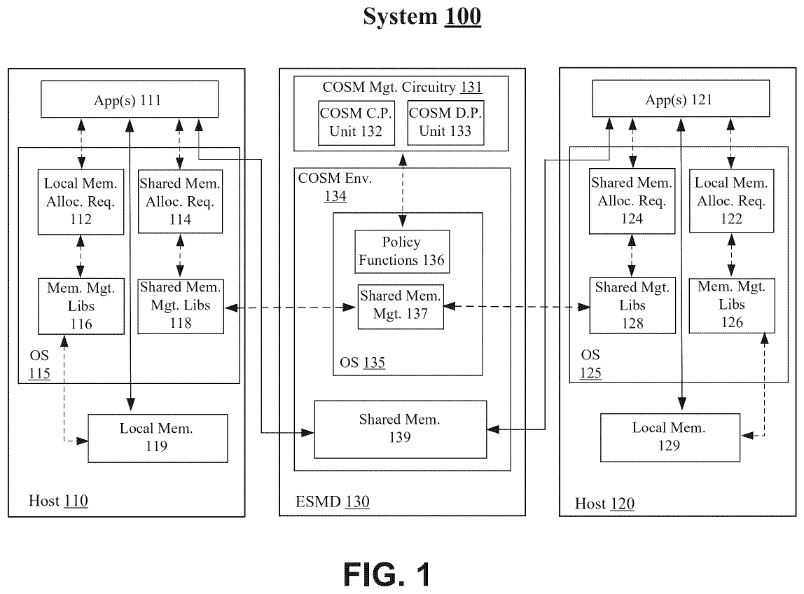

FIG. 1 illustrates an example system 100. According to some examples, as shown in FIG. 1, system 100 includes a host 110, a host 120 and an externally attached shared memory device (ESMD) 130. Also as shown in FIG. 1, host 110 can be configured to host one or more applications (App(s)) 111, an operating system (OS) 115 and maintain or include a local memory 119.

Host 120 can be similarly configured to host one or more applications 121, an OS 125 and maintain or include a local memory (mem.) 129. In some examples, application(s) 111 and application(s) 121 can place a respective local memory (mem.) allocation (alloc.) request (req.) 112, 122 to respective OSs 115, 125 for use of and/or access to one or more memory regions maintained in respective local memories 119, 129. For these examples, OS 115 and OS 125 can use their respective memory (mem.) management (mgt.) library (libs.) 116, 126 to allocate memory regions maintained in respective local memories 119, 129 to allow application(s) 111 and 121 to access these respective local memories.

Examples of applications 111 and 121 can include one or more of: a microservice, virtual machine (VM), microVM, container, process, thread, or other virtualized execution environment.

According to some examples, as shown in FIG. 1, ESMD 130 includes controlled shared memory (COSM) management (mgt.) circuitry 131, an OS 135 and shared memory 139. Also as shown in FIG. 1, and described in more detail below, COSM management circuitry 131 can include a COSM control plane (C.P.) unit 132 and a COSM data plane (D.P.) unit 133 that can be arranged or configured to set up and implement/enforce an isolation mechanism for access to one or more shared memory regions maintained in shared memory 139. A COSM environment (env.) 134 can be established at ESMD 130 by COSM management circuitry 131 that can include OS 135 implementing policy functions 136 and shared memory (mem.) management (mgt.) 137 for access to one or more memory regions maintained in shared memory 139 based on the isolation mechanism that can include two levels. This two-level mechanism, as will be described more below, can include host-level access control as a first level and data-level inspection and enforcement as a second level. For example, respective application(s) 111, 121 can place a respective shared memory allocation request 114, 124 to respective OSs 115, 125 for use of and/or access to the one or more memory regions maintained in shared memory 139. OSs 115, 125 can be configured to coordinate with shared memory management 137 via establishment of respective shared memory (mem.) management (mgt.) libraries (libs) 118, 128 to enable application(s) 111 or application(s) 121 to access one or more memory regions maintained in shared memory 139 based, at least in part, on policy or rules enforced by policy functions 136.

As described herein, application(s) 111 or application(s) 121 can execute on behalf of a tenant (e.g., network operator) to perform network functions. For example, network functions can perform operations of a Centralized Unit (CU), Distributed Unit (DU), RAN Intelligent Controller (RIC), Access and Mobility Management Function (AMF), User Plane Function (UPF), or other 5G or 5GC network functions or components defined at least in 3rd Generation Partnership (3GPP) Fifth-generation wireless technology (5G) Release 15 (2018), 3GPP NextG Core (5GC) Release 16 (2020), and earlier versions, later versions, and revisions thereof.

For example, ORAN CU can perform processing of protocols, including Service Data Adaption Protocol (SDAP), Packet Data Convergence Protocol (PDCP), and Radio Resource Control (RRC). For example, 5G DU can perform processing of physical layer interface (PHY) resource mapping, beamforming, or fast fourier transform (FFT); media access control (MAC); and Radio Link Control (RLC). For example, 5G RIC can create and deploy processes, including network functions, and analyze network traffic to perform predictive maintenance, anomaly detection, and resource management.

For example, 5GC AMF can manage the connection and mobility of user equipment (UE) within a network. For example, 5GC UPF can manage user data traffic, specifically packet routing, forwarding, and Quality of Service (QOS) handling.

According to some examples, shared memory 139 can include in-memory compute logic or circuitry (not shown) capable of executing sensitive computations within memory buffers maintained in shared memory 139. These memory buffers can have a self-destructive capability that automatically erases data associated with the computations executed by the in-memory compute logic or circuitry. This self-destructive capability can prevent persistence of data associated with the computations executed by the in-memory compute logic or circuitry and can prevent or reduce a risk of an unauthorized retrieval of this data.

Local memories 119, 129 or shared memory 139 can include volatile and/or non-volatile types of memory. In some examples, local memories 119, 129 or shared memory 139 can include one or more dual in-line memory modules (DIMMs) that are arranged to include any combination of volatile or non-volatile memory. Volatile memory include memory whose state (and therefore the data stored on it) is indeterminate if power is interrupted to the device. Volatile memory can include a cache. Nonvolatile memory can include memory whose state is determinate even if power is interrupted to the device. Dynamic volatile memory refreshes the data stored in the device to maintain state. According to some examples, as mentioned above, local memories 119, 129 or shared memory 139 can include various types of non-volatile memory.

Although not shown in FIG. 1, host 110, host 120 or ESMD 130 may include additional components that facilitate inter-process communications and use of shared memory 139. For example, various network and/or internal communication interfaces and associated interconnects can communicatively couple the elements shown in FIG. 1 to each other or to elements on other hosts or ESMDs (not shown in FIG. 1).

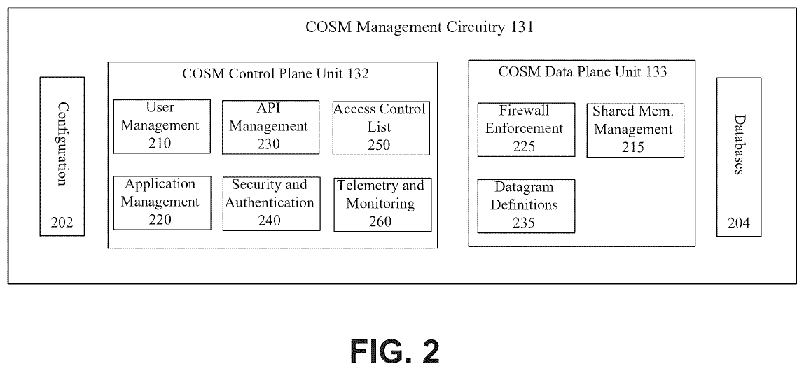

FIG. 2 illustrates example COSM management circuitry 131. In some examples, FIG. 2 shows example logical modules, configurations or databases that can be implemented by hardware circuitry, firmware, and/or software executed on an ESMD such as ESMD 130. For these examples, COSM management circuitry 131 may include a COSM control plane unit 132 and a COSM data plane unit 133. The COSM control plane unit 132 may be responsible for managing the configuration and establishment of memory-based communication channels in ESMD 130. With a memory-based communication channel configured, COSM data plane unit 133 may manage operation of the memory-based communication channel following configuration, enforcing isolation policies and providing services to be used in the respective memory-based communication channels based on the configurations.

According to some examples, ESMD 130 can include two or more input/output (I/O) ports to couple to devices representing different hosts or host domains. A domain can be defined as a set of system resources (e.g., hosts), to which certain users (e.g., operators or tenants) can have prescribed access rights as governed by security policies or service level agreements. COSM control plane unit 132 can interface with the attached devices to present ESMD 130 as a memory device (e.g., sharable memory device) accessible by the attached devices via their respective interconnect. For example, interconnects arranged to operate using peripheral component interface express (PCIe) protocols, compute express link (CXL) protocols, Ethernet protocols and/or other type of interconnect protocols.

User management 210 can be arranged to identify a particular device, operating system, hypervisor, etc. of a host or host domain and determine attributes of the corresponding host and/or host domain, including policies and configurations to be applied for the host and/or host domain. User management 210 can further identify various applications (e.g., applications, services, processes, virtual machines (VMs), microVMs, or threads) that can run on the host or host domain's OS or hypervisor and that may utilize communication channels implemented by ESMD 130. Application management 220 may identify, for the applications of each host and/or host domain, attributes, permissions, policies, and preferences for the applications so as to configure the manner in which individual applications can access and use memory-based communication channels (and their corresponding buffers or memory regions) implemented in ESMD 130. For instance, one or more buffers or memory regions or memory-based communication channel configured in ESMD 130 (e.g., maintained in shared memory 139) to enable communication between two or more host and/or host domain devices can be called upon, in some examples, to be used by multiple, distinct applications of a host and/or host domain, and application management 220 can configure the memory-based communication channel to establish isolation rules and policies that can govern how or if the applications share the memory-based communication channel, among other example configurations and considerations.

Continuing with the example of FIG. 2, API management 230 can be provided in some implementations to assist in configuring ESMD 130 and respective memory-based communication channels configured in ESMD 130 to interoperate in a system where ESMD 130 couples through an external switch or another ESMD to one or more host or host domains, with the memory-based communication channel being configured to consider the routing, protocols, and other attributes of the potential one-to-many coupling of ESMD 130 to potentially multiple distinct host or host domains through a single input/output (I/O) interface of ESMD 130, among other examples. Security and authentication 240 can be arranged to define and enforce security and authentication protocols (e.g., at the host, host domain or application level) for the memory-based communication channels, such that specific security features and/or policies are configured for the memory-based communication channels. Further, an access control list 250 can govern types of allowed or non-allowed accesses to ESMD 130. For example, enforcing access controls and permissions of the configuration port of an ESMD such as ESMD 130. Telemetry monitoring can also be managed for memory-based communication channels of specific hosts, host domains and/or applications. For instance, in accordance with QoS guarantees for various domains or applications. Telemetry monitoring access can be controlled using telemetry monitoring manager 260, among other example modules and logical blocks. For example, telemetry and monitoring 260 can provide telemetry data indicative of utilization of memory (e.g., memory bandwidth, memory addresses accessed, or others) and/or utilization of compute resources (e.g., accelerator or processor utilization or busyness, or others). The busyness level can represent a number of cycles consumed by instructions and the software application executed on a particular core and exclude polling for work to perform. Other examples of levels of busyness can include quantized levels of utilization from not utilized (e.g., 0) to fully utilized (e.g., 5), average utilization over a timespan, or others.

COSM management circuitry 131 of an example ESMD such as ESMD 130 can additionally include COSM data plane unit 133 to govern the operation of various memory-based communication channels (and corresponding buffers or memory regions) configured in the shared memory maintained at ESMD 130 (e.g., shared memory 139) in accordance with configurations 202. Configurations 202, for example, can be set or implemented using COSM control plane unit 132. Individual buffers, memory regions and memory-based communication channels can have respective functionality, rules, protocols, and policies defined for the channel, and these channel or buffer definitions may be recorded within database 204. The COSM data plane unit 133 may include, for instance, shared memory management 215 to identify one or more portions of shared memory (e.g., buffers or memory regions) and associated in-memory compute logic or circuitry maintained at ESMD 130 to allocate for a specific memory-based communication channel and define pointers to provide to the host or host domain devices that are to communicate over the memory-based communication channel to enable the devices' access to the memory-based communication channel. Shared memory management 215 can leverage these pointers to effectively “turn off” or at least limit a device's or application's access and use of the memory-based communication channel by retiring the pointer, disabling the device's ability to write data on the buffer (to send data on the memory-based communication channel) or read data from a buffer (to receive/retrieve data on the memory-based communication channel), among other example functions.

Other security and data filtering functions may be available for use in a memory-based communication channel, based on the configuration and/or policies applied to the memory-based communication channel, such as firewalling by firewall enforcement 225 (e.g., to enforce policies that limit certain data from being written to or read from a buffer or memory region) or data filtering (e.g., at the field level) associated with datagram definitions 235.

Datagram definition 235 can be based on a data format of data written to or read from the memory-based communication channel (e.g., based on a protocol or other datagram format (including proprietary data formats) defined for the memory-based communication channel), to identify the presence of certain sensitive data to filter or redact such data and effectively protect such information from passing over the memory-based communication channel (e.g., from a more secure or higher trust domain to a less secure or lower trust domain), among other examples.

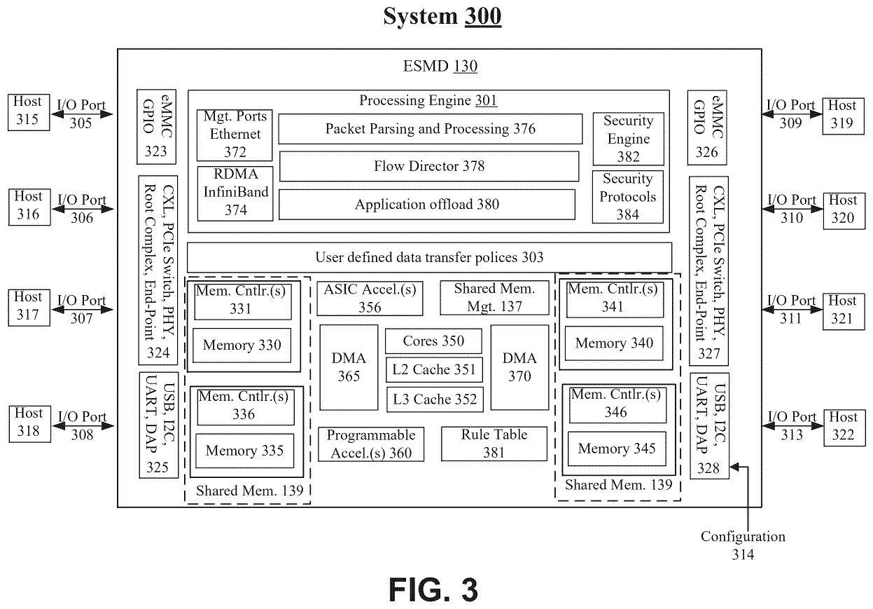

FIG. 3 illustrates an example system 300. According to some examples, as shown in FIG. 3, system 300 includes ESMD 130 coupled with a different set of hosts 313-322 through separate I/O ports 305-313. Hosts 315-322 can be associated with two or more different domains (e.g., domains of different ownership, trust levels, security features or permissions, etc.). Different interconnect protocols may be supported by the various I/O ports 305-313 of ESMD 130 (such as PCIe, CXL, Ethernet, ultra path interconnect (UPI), universal chiplet interconnect express (UCIe), NVLink, embedded multi-media controller (eMMC), general purpose I/O (GIPO), universal serial bus (USB), inter-integrated circuit (I2C), universal asynchronous receiver transmitter (UART), debug adaptor protocol (DA), etc.) and corresponding protocol logic (e.g., 323-324) may be provided on ESMD 130 to enable ESMD 130 to connect to, train, and communicate with the hosts 315-322 over corresponding links.

In some examples, one of the ports from among I/O ports 305-313 or an additional I/O port can be provided as a configuration channel 314, to enable a user or system to interface with ESMD 130 and configure functionality of the ESMD 130, define configurations for connections and communication with ESMD 130 (e.g., by hosts 315-322), define policies and rules that may be applied to memory-based communication channels implemented on ESMD 130, configure cross-domain and/or shared memory services provided by or through the hardware, firmware, and/or software executed on the ESMD 130, among other example features.

According to some examples, as mentioned briefly above for FIG. 1, ESMD 130 can also include shared memory 139. Shared memory 139 can include one or more memory elements (e.g., memory 330, 335, 340, 345), at least a portion of which can be offered as shared memory and implement buffers or memory regions through which two-level isolation schemes can be applied to implement memory-based communication channels between applications or processes hosted by two or more hosts (e.g., 315-323) or by a same host through an exchange of data over or through one or more shared buffers or memory regions. Portions of memory 330, 335, 340, 345 arranged to maintain memory regions or buffers designated for use as shared memory may be presented by ESMD 130 to hosts 315-322 as shared memory (e.g., using semantics of the corresponding interconnect protocol through which the host device connects to ESMD 130). Shared memory management 137 of ESMD 130 can be arranged to coordinate access to the shared memory by hosts 315-322 in cooperation with corresponding memory controllers 331, 336, 341, 346. That coordinated access can include performance of read or write memory operations on respective memory elements memory 330, 335, 340, 345. Also, in-memory compute logic or circuitry (not shown) can be integrated into one or more memory elements 330, 335, 340 or 345 to execute workloads involving sensitive data and use of one or more self-destructive buffers included in these one or more memory elements to ensure data persistence is minimized for that sensitive data. ESMD 130 can further include direct memory access (DMA) engines 365 or 370 to enable direct memory access (e.g., DMA reads and writes) by hosts 315-322) coupled to ESMD 130 and utilizing one or more memory regions or buffers of shared memory 139 for memory-based communication channels.

In some examples, one or more central processing unit (CPU) processor cores 350 can be provided on ESMD 130 to execute instructions and processes to implement the memory-based communication channel via use of one or more memory regions or buffers maintained in shared memory 139 in order to provide various cross domain services in connection with these one or more memory regions or buffers. The various cross domain service can be based on a respective configuration, isolation rules, and/or isolation policies defined for the one or more memory regions or buffers). The isolation rules and/or isolation policies can be maintained, for example, in rule table 381 at ESMD 130.

A cache hierarchy that includes level-2 (L2) cache 351 and level-3 (L3) cache 352 can be provided, and cores 350 can be arranged to interoperate with other processing/compute elements provided on the ESMD 130 such as one or more application specific integrated circuit (ASIC) accelerators (accel. (s)) 356 (e.g., cryptographic accelerators, error correction and detection accelerators, etc.) and various programmable hardware accelerators 360 (e.g., graphics accelerators (e.g., GPU), networking accelerators, machine learning accelerators, matrix arithmetic accelerators, field programmable gate array (FPGA)-based accelerators, etc.). In addition to in-memory compute logic/circuitry being included in at least some memory elements of shared memory 139, specialized processing functionality and acceleration capabilities (e.g., provided by ASIC accelerator(s) 356 or programmable accelerator(s) 360, etc.) can be leveraged to support memory-based communication channels provided through sharing one or more memory regions or buffers maintained in shared memory 139 of ESMD 130, based on configurations and rules defined for the memory-based communication channel (e.g., maintained in rule table 380).

According to some examples, logic and/or features can be provided on ESMD 130 to implement various cross domain services in connection with a memory-based communication channel established between hosts 315-322 via use of one or more memory regions or buffers maintained in shared memory 139. Such logic and/or features can be implemented in hardware circuitry (e.g., of accelerator devices (e.g., 356, 360), functional IP blocks, etc.), firmware or software (e.g., executed by cores 350). For these examples, functional cross domain service modules can thereby be implemented, such as modules that assist in emulating particular protocols, corresponding packet processing, and protocol features in a given memory-based communication channel (e.g., providing Ethernet-specific features (e.g., Dynamic Host Configuration Protocol (DHCP)), etc.) using an Ethernet port management module (e.g., 372), or remote DMA (RDMA) and InfiniBand features using an RDMA and/or InfiniBand module (e.g., 374). Various packet parsing and processing may be performed at ESMD 130 using, for example, packet parsing and processing 376, for instance, to parse packets written to a memory-based communication channel shared memory region or buffer and performing additional services on the packet to modify the packet or prepare the packet for reading by another host or device coupled to the memory-based communication channel shared memory region or buffer. Application management tasks may also be performed, including routing tasks (e.g., using a flow director 378) to influence the manner in which data communicated over a memory-based communication channel shared memory region or buffer is consumed and routed by the host or host domain receiving the data (e.g., specifying a process, core, virtual machine (VM), etc. at the host that should handle further processing of the data (e.g., based on packet inspection performed at ESMD 130), among other examples.

Application offload 380 can be used to leverage information concerning a network connection of one of the hosts coupled to ESMD 130 to cause data read by the host to be forwarded in a particular manner on a network interface controller or other network element on the device (e.g., to further forward the data communicated over ESMD 130 supported memory-based communication channel to other hosts over the network). In other examples, ESMD 130 can perform various security services on data written and/or read from a memory-based communication channel shared memory region or buffer implemented on ESMD 130, for instance, applying custom or pre-defined security policies or tasks (e.g., using a security engine 382), applying particular security protocols to the communications carried over/through the memory-based communication channel shared memory region or buffer (e.g., IPSec using security protocols 384), among other example cross domain services and functionality.

According to some examples, an Internet Protocol (IP) network can be at least partially replaced using one or more (or a network of) ESMDs. For these examples, ESMDs such as ESMD 130 can be utilized to implement cross-domain collaboration that allows information sharing to become more intent-centric. For instance, one or more applications executed in a first domain at a first host and the transactions required for communications with other applications of a different domain at the first host or a second host can be first verified for authenticity, security, or other attributes (e.g., based on an application's or domain's requirements), thereby enforcing implicit security. Memory-based communication can also offer a more reliable data transfer and simpler protocol operations for retransmissions and data tracking (e.g., than a more conventional data transfer over a network or interconnect link (which may be emulated by the memory-based communication). Through such simpler operations, ESMDs solutions can offer high-performance communication techniques between interconnecting domain-specific computing environments. Further, memory interfaces in an ESMD can be enforced with access controls and policies for secure operations, such as implementing a permission matrix scheme that can include a type of data-diode which cause memory-based communication channels to operate in a unidirectional fashion with permission-based access controls, such as write-only access, read-only access, and read/write access to access one or more memory-based communication channel shared memory regions or buffers. In other instances, a memory-based communication interface maintained by the ESMD can enable bi-directional communication between different hosts or different host domains. In some examples, separate memory regions or buffers can be used to facilitate each direction of communication (e.g., one memory region/buffer for communication from host A to host B and another memory region/buffer for communication from host B to host A). In such cases, different policies, cross domain services, and even protocols can be applied to each memory region/buffer, based on the disparate characteristics and requirements of the different hosts or host domains, among other example implementations. Generally, these memory-based communication interfaces can be a standard implementation and can also be open-sourced for easier use, community adoption, and public participation in technology contributions without compromising the security and isolation properties of the data transactions. The open implementation also provides transparency of communication procedures over open interfaces to identify any security vulnerabilities.

An ESMD can enable support for application-defined communication protocols over open interface definitions (and open implementation), allowing customized communication solutions, which are wholly independent of or at least partially based on (and emulate) interconnect protocols. For instance, application-defined communication protocols may enable applications to create their own datagram format, segmentation, encryption, and flow control mechanisms that are decoupled from the protocols used in the ESMD memory-based communication channel interfaces (connecting the ESMD to hosts).

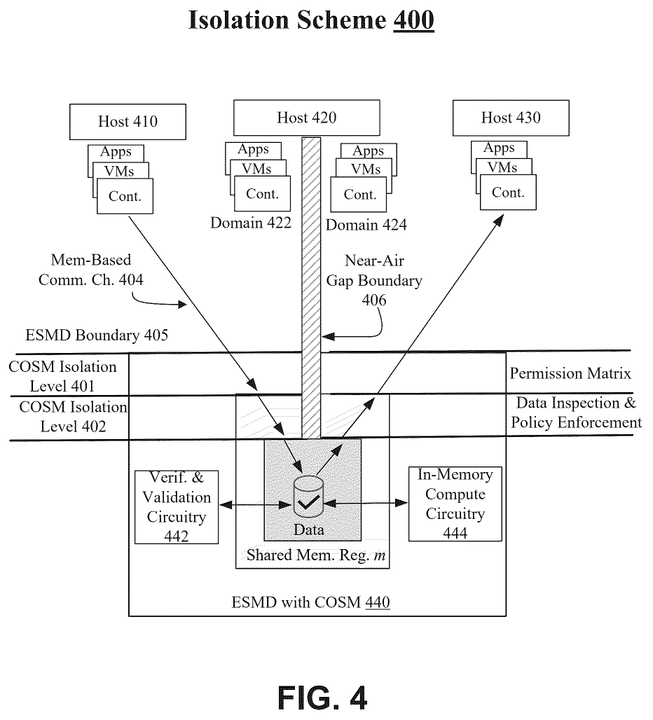

FIG. 4 illustrates an example isolation scheme 400. In some examples, hosts 410, 420 or 430 may be arranged to share access to a shared memory region m maintained at an ESMD with COSM 440. Although not shown in FIG. 4, ESMD with COSM 440 can be configured and/or include similar COSM management circuitry as shown in FIG. 2 for COSM management circuitry 131 and similar functional hardware and logic/features as shown in FIG. 3 for ESMD 130. For these examples, isolation scheme 400 can include establishment of a memory-based communication channel 404 to enable applications, VMs or containers (conts.) hosted by host 410 and host 430 to read and/or write data to shared memory region m based, at least in part, on a first COSM isolation level 401 and a second COSM isolation level 402.

In some examples, as shown in FIG. 4, ESMD with COSM 440 can also include verification (Verif.) and validation circuitry 442 and in-memory compute circuitry 444. Verification and validation circuitry 442 and in-memory compute circuitry 444 can be integrated or embedded within memory elements that maintain or include shared memory region m. In some examples, for in-memory compute operations, shared memory region m can operate according to an in-memory compute technology. The in-memory compute technology can also be based on analog computations or digital computations for in-memory compute operations. In some examples, verification and validation circuitry 442 can be included in COSM management circuitry (e.g., as part of COSM data plane unit) and in-memory compute circuitry 444 can be integrated or embedded within memory elements that maintain or include shared memory region m. For either of these examples, sensitive workloads can be executed directly within shared memory region m and shared memory region m can be arranged to implement buffer destruction mechanisms to cause data associated with execution of the sensitive workloads to be automatically erased after verification & validation circuitry 442 has validated post-execution computations of the sensitive workloads by in-memory compute circuitry 444. Verification and validation can include use of error correction codes such as parity bits or cyclic redundancy check (CRC) to determine if calculated results have errors (e.g., caused by bit flips during in-memory compute operations). The sensitive workloads, for example, can be required by applications, VMs or containers hosted by host 410, 420 or 430 and computations performed by in-memory compute circuitry can include, but are not limited to, encryption computations, data integrity checker computations (e.g., checksum or cyclic redundancy check (CRC)), or decryption computations. Packet traffic data (e.g., header and/or payload) and can be encrypted and stored in COSM 440. Packet traffic data (e.g., header and/or payload) and can be decrypted after being read from COSM 440.

According to some examples, COSM isolation level 401 can be based on a permission matrix scheme that can be arranged to either permit or block applications, VMs or containers hosted by host 410 or host 430 to read/or write data to shared memory region m. For example, the permission matrix can permit applications, VMs or containers hosted by host 410 to conduct at least write operations to shared memory region m and permit applications, VMs or containers hosted by host 430 to conduct at least read operations to shared memory region m. COS isolation level 401 can be implemented at ESMD boundary 405 to allow or block write operations from host 410 or read operations from host 430.

In some examples, COSM isolation level 402 can be based on data inspection and policy enforcement associated with data to be written to or read from shared memory region m. Data inspection and policy enforcement can include inspecting each data transaction (e.g., memory write or read operation) to shared memory region m before that data transaction is processed. For example, policies can be enforced that can include, but are not limited to, verifying a data format and security associated with the data transaction (e.g., ensuring encrypted payloads, structured database records, compliance with industry regulations) and allowing the data transaction if compliant to the policies or taking policy-based actions if the data transaction is not compliant to the policies. Policy-based actions can include, but are not limited to, modifying, deleting, blocking, or generating a notification to a management entity (e.g., a system management orchestrator) to indicate that a non-compliant data transaction was detected for accessing shared memory region m.

According to some examples, a second memory-based communication channel (not shown) similar to memory-based communication channel 404 can be established between two domains 422 and 424 hosted by host 420. For these examples, the second memory-based communication channel can be subject to the same two-level isolation scheme that effectively creates a near-air gap boundary 406 between applications, VMs and containers included in domain 422 and applications, VMs and containers included in domain 424. The near-air gap boundary 406 is shown in FIG. 4 to indicate that a two-level isolation scheme such as example isolation scheme 400 can emulate an air-gap (physical isolation) of shared memory region m when shared between two domains or shared between two hosts hosting respective domains.

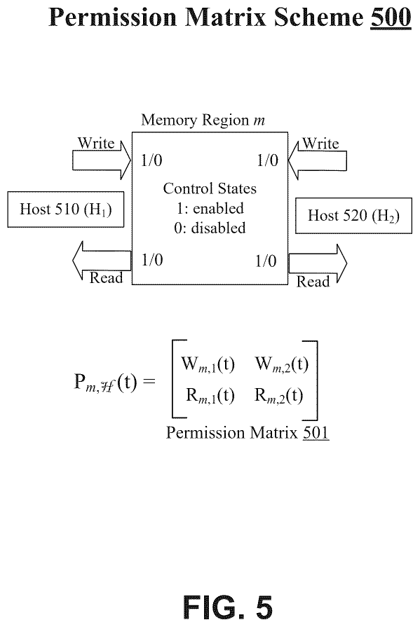

FIG. 5 illustrates an example permission matrix scheme 500. According to some examples, example permission matrix scheme 500 can represent a portion of a controlled shared memory (COSM) framework implemented at an ESMD. For these examples, permission matrix scheme 500 includes use of permission matrix 501 for fine-grained filtering and control at the granularity of individual hosts that are shown in FIG. 5 as host 510 and host 520 and at the granularity of an individual memory region shown in FIG. 5 as memory region 539. Memory region 539, for example, is maintained at the ESMD and is arranged to be shared by host 510 and host 520. For example permission matrix 501, “Pₘ” indicates that this is a permission matrix for shared memory region m and “H” denotes a set of distinct hosts {H₁, H₂, . . . ,Hₙ, . . . ,H_{N}} that can participate in permission matrix scheme 500 and “m” denotes a set of distinct (non-overlapping) memory regions [M₁, M₂, . . . , Mₘ, . . . , M_{M}]. A given memory region Mₘ can be characterized by a memory address of the start of memory region Mₘ and a memory address of the end of memory region Mₘ.

In some examples, memory region 539 can represent a given memory region Mₘ. and host 510 can represent a given host H₁ and host 520 can represent a second given host H₂. For these examples, host 510 and host 520 can be configured for sharing memory region 539 based on an underlying memory technology or standard (e.g., CXL). Both host 510 and host 520 can have two degrees of freedom for sharing memory region 539: write permission and read permission, which may change with time t. The variable “t” indicates a type of time-dependent control of shared memory region 539. For example permission matrix 501, if W_{m,1}(t)=1, host 510 (H₁) is permitted to write data to memory region 539 (m) at time t and if W_{m,1}(t)=0, host 510 (H₁) is blocked or prohibited from writing data to memory region 539 (m) at time t. Also, if R_{m,1}(t)=1, host 510 (H₁) is permitted to read data from memory region 539 (m) at time t and if R_{m,1}(t)=0, host 510 (H₁) is blocked or prohibited from writing data to memory region 539 (m) at time t. Similarly, if W_{m,2}(t)=1, host 520 (H₂) is permitted to write data to memory region 539 (m) at time t and if W_{m,2}(t)=0, host 520 (H₂) is blocked or prohibited from writing data to memory region 539 (m) at time t. Also, if R_{m,2}(t)=1, host 520 (H₂) is permitted to read data from memory region 539 (m) at time t and if R_{m,2}(t)=0, host 520 (H₁) is blocked or prohibited from writing data to memory region 539 (m) at time t.

According to some examples, permission matrix 501 can be used as a mechanism to ensure that hosts 510 or 520 can access shared memory region 539 with tailored read/write permissions. For example, shared memory region 539 may be a critical shared memory region and host 510 may need to perform real-time updates to data maintained in shared memory region 539 to perform real-time updates and thus may have write access to shared memory region 539, while other hosts such as host 520 are restricted to read-only permissions to prevent accidental overwrites or data corruption. This type of fine-granular control enables precise enforcement of access policies, minimizing risks of unauthorized data manipulation or accidental interference in multi-host environments.

In some examples, permission matrix 501 can allow for a type of permission matrix filtering that facilitates dynamic and context-aware memory management. For example, an ESMD such as ESMD 130 can be configured to update permissions on the fly based on an operational state of a system or based on application requirements. Updated permissions can include granting temporary write access to a host for a specific task and then revoking the permission once the task is complete. This type of flexibility can be important in scenarios involving hierarchical or distributed memory allocation, where different hosts or processes may have varying levels of privilege. By enabling a fine-granular level of control, the ESMD can improve both security and performance by allowing shared memory that can be utilized efficiently without compromising the integrity of data or system operations.

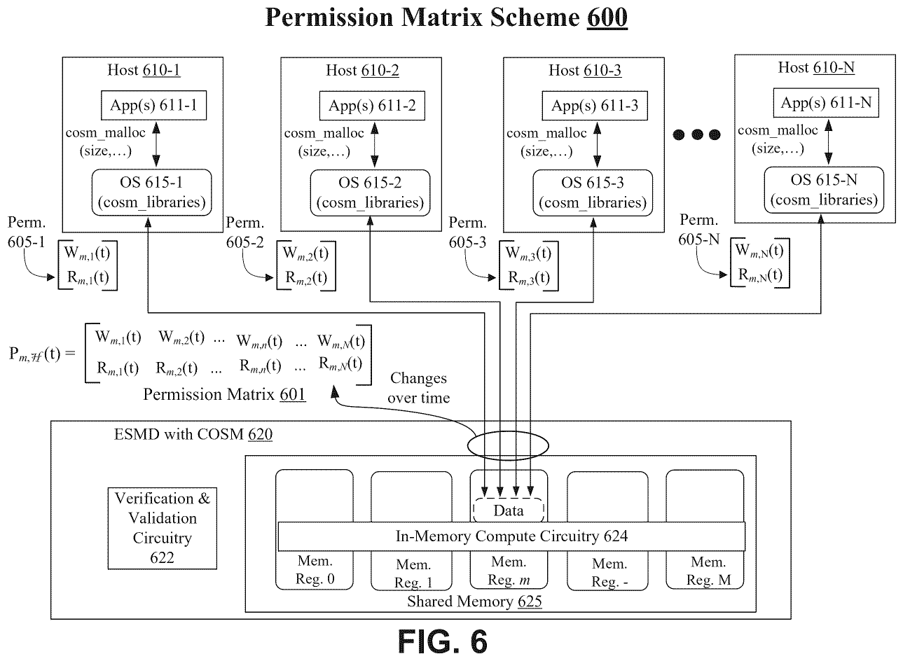

FIG. 6 illustrates an example permission matrix scheme 600. According to some examples, permission matrix scheme 600 shows use of a permission matrix 601 to control access by applications 611-1 to 611-N hosted by Hosts 610-1 to 610N to data maintained in shared memory region (mem. reg.) m maintained at ESMD with COSM 620. Although not shown in FIG. 6, ESMD with COSM 620 can be configured to include similar COSM management circuitry as shown in FIG. 2 for COSM management circuitry 131 and similar functional hardware and logic/features as shown in FIG. 3 for ESMD 130. For these examples, the variables of permission matrix 601 can be used in a similar manner as mentioned above for permission matrix 501 to indicate write or read permissions of hosts 610-1 to 610-N at time t. The individual permissions included in permission matrix 601 are shown in FIG. 6 as permissions 605-1 to 605-N.

In some examples, logic and/or features of COSM management circuitry for ESMD with COSM 620 (e.g., control plane unit 132 of COSM management circuitry 131) can moderate access control to memory region m maintained in memory 625 by setting permissions for each host from among hosts 610-1 to 610-N through permission matrix 601. For these examples, once permissions to access memory region m are completed, applications 611-1 to 611-N can use library functions (cosm_libraries) maintained by respective OSs 615-1 to 615-N to place memory allocation requests (cosm_malloc size, . . . ) to allocate memory addresses and to access those allocated memory addresses via read or write operations.

According to some examples, as shown in FIG. 6, shared memory 625 includes in-memory compute circuitry 624. In-memory compute circuitry 624 can be capable of executing sensitive computations within memory buffers maintained in at least a portion of the memory regions maintained in shared memory 625. Similar to the memory buffers mentioned above for FIG. 4, these memory buffers can have a self-destructive capability that automatically erases data associated with the computations executed by the in-memory compute circuitry 624. This self-destructive capability can prevent persistence of data associated with the computations executed by in-memory compute circuitry 624 and can prevent or reduce a risk of an unauthorized retrieval of this data. Also, prior to implementation of buffer destruction mechanisms to cause data associated with execution of the sensitive workloads to be automatically erased, verification & validation circuitry 622 can be configured to validate post-execution computations of the sensitive workloads by in-memory compute circuitry 624.

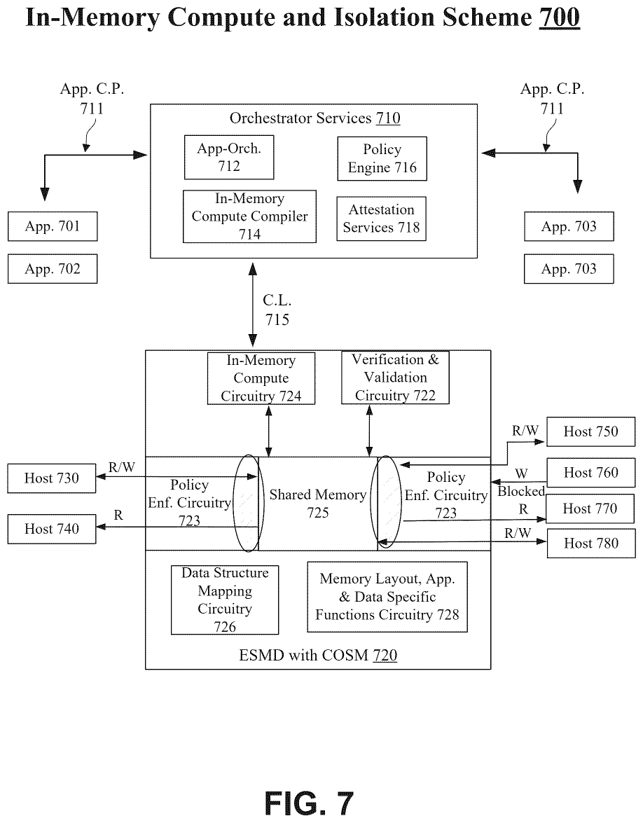

FIG. 7 illustrates an example in-memory compute and isolation scheme 700. In some examples, as shown in FIG. 7, in-memory compute and isolation scheme 700 can include orchestrator services 710 communicatively coupled with applications 701, 702, 703 and 705 through an application (App.) control plane (C.P.) 711 and communicatively coupled with ESMD with COSM 720 through communication link (C.L.) 715. Although not shown in FIG. 7, ESMD with COSM 720 can be configured to include similar COSM management circuitry as shown in FIG. 2 for COSM management circuitry 131 and similar functional hardware and logic/features as shown in FIG. 3 for ESMD 130.

According to some examples, as shown in FIG. 7, orchestrator services 710 can include an application-orchestrator (App-Orch.) 712, a policy engine 716, an in-memory compute compiler 714, or attestation services 718. For these examples, application-orchestrator 712 can be configured to communicate with applications 701, 702, 703 or 705 via application control plane 711 to receive in-memory compute requests that include in-memory computations at shared memory 725 maintained at ESMD with COSM 720. Policy engine 716 and/or attestation services 718 can be configured to determine whether a particular application is authorized to request in-memory compute for shared memory 725. If authorized, in-memory compute compiler 714 can be capable of causing in-memory compute circuitry 724 to be configured for in-memory computations based on respectively authorized in-memory compute requests from applications 701, 702, 703 or 705.

Configuration of in-memory compute circuitry 724 can also include allocating secure memory buffers included in shared memory 725. Secure memory buffers can at least temporarily store data associated with in-memory compute computations executed by in-memory compute circuitry 724 responsive to authorized in-memory compute requests. According to some examples, this collaboration between ESMD with COSM 720 and orchestrator services 710 for configuring in-memory compute circuitry 725 and shared memory 725 can enforce dynamic, real-time memory access and in-memory compute operations that can protect sensitive data associated with execution of security-sensitive workloads in a multi-tenant infrastructure. This type of dynamic collaboration can be used for multi-tenant environments such as open radio access networks (O-RAN), cloud computing, or industrial automation. For example, radio intelligent controller (RIC) and security management operations (SMOs) can be able to dynamically adapt memory access or in-memory compute enforcement policies based on workload demand.

In some examples, a data structure mapping circuitry 726 maintained at ESMD with COSM 720 can be configured to assist with the mapping of shared memory regions of shared memory 725 to hosts 730, 740, 750, 760, 770, or 780 in a similar manner as described above for data transfer scheme 700. Also, memory layout, application (App.) & data specific functions circuitry 728 can be configured to assist with the memory layout of the shared memory regions of shared memory 725 to facilitate use of shared memory 725 for workloads associated with authorized in-memory compute requests to be executed by in-memory compute circuitry 724. This facilitation can include setting up memory buffers in shared memory 725 to have self-destructive capabilities that automatically erases data associated with the computations executed by in-memory compute circuitry 724. Also, prior to implementation of buffer destruction mechanisms to cause data associated with execution of the sensitive workloads to be automatically erased, verification & validation circuitry 722 can be configured to validate post-execution computations of the sensitive workloads by in-memory compute circuitry 724. In some examples, data structure mapping circuitry 726 and memory layout, application & data specific functions circuitry 728 can be included in COSM management circuitry (e.g., part of a COSM data plane unit) of ESMD with COSM 720.

According to some examples, ESMD with COSM 720 can also include policy enforcement (Enf.) circuitry 723. Policy enforcement circuitry 723 can be configured to implement a similar two-level isolation scheme as described above for isolation scheme 400 that includes use of a first level of isolation that uses a permission matrix similar to permission matrix 601 shown in FIG. 6. Also as described above, the similar two-level isolation scheme can include a second level of isolation that includes data inspection and policy enforcement as mentioned for isolation scheme 400. For example, as shown in FIG. 7, the end point arrow heads between shared memory 725 and hosts 730, 740, 750, 760, 770 or 780 can indicate what permissions are allowed for a particular host. For this example, hosts 730, 750 and 780 have arrow heads on both end points to indicate permission for read and write memory transactions to shared memory 725. Arrow heads on the end point on only the host side for hosts 740 and 770 indicates permission for only read memory transactions to shared memory 725. Also, a blocked write request from host 760 is shown in FIG. 7 as being at the ESMD with COSM 720 boundary to indicate that host 760 does not have write access permission to shared memory 725.

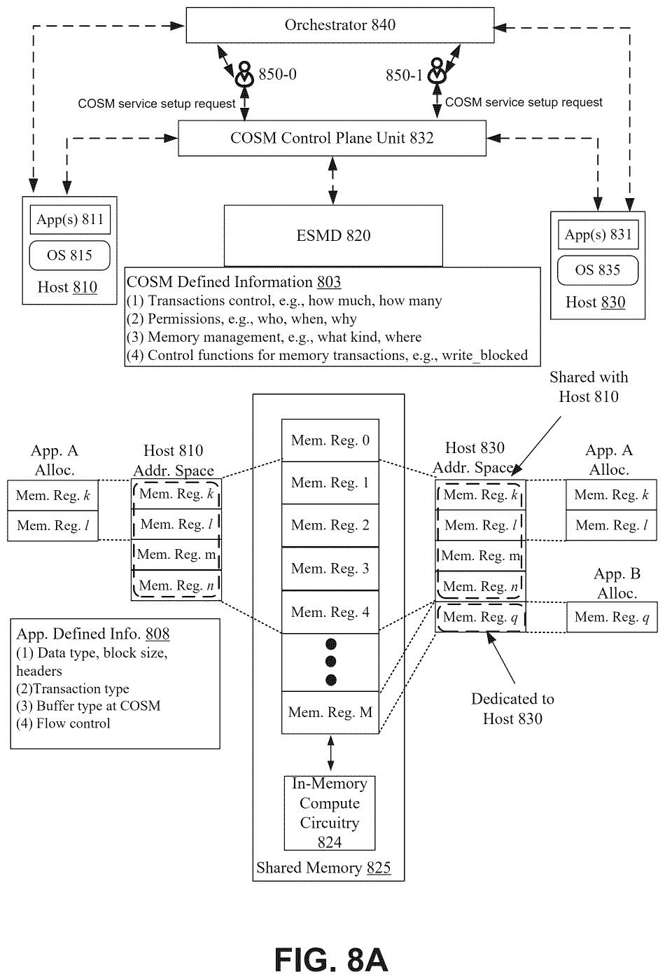

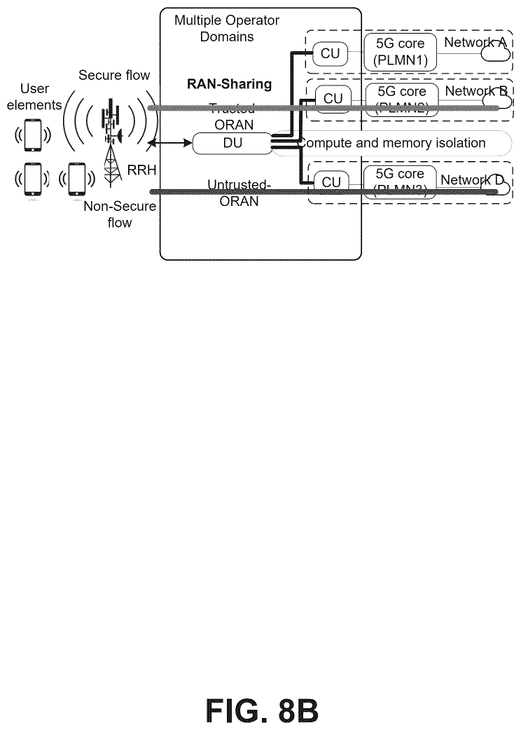

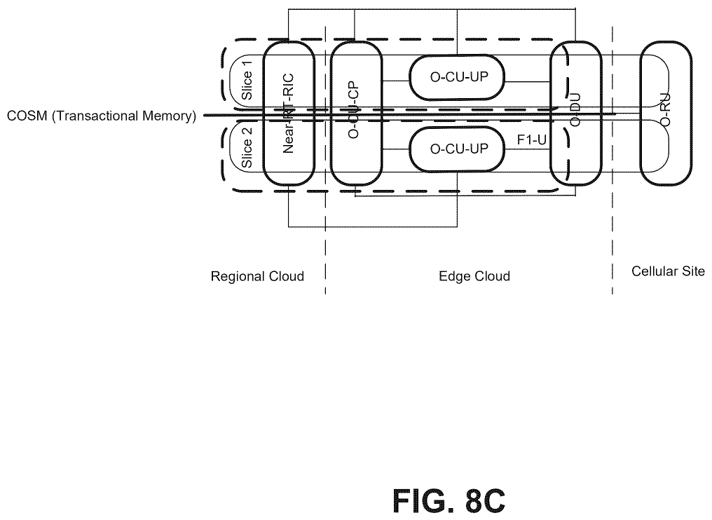

FIG. 8A depicts an example system. In some examples, as shown in FIG. 8A, data transfer scheme includes a COSM control plane unit 832 in communication with an ESMD 820 and in communication with hosts 810 and 820. For these examples, although not shown in FIG. 8A, COSM control plane unit 832 can be configured to include similar logic and/or features included in COSM control plane unit 132 of COSM management circuitry 131 described above for and shown in FIG. 2. Also, ESMD 820 can include similar functional hardware and logic/features described above for and shown in FIG. 3.

According to some examples, data transfer scheme 800 can illustrate a general approach for an end-to-end data transfer between applications hosted by hosts 810 and 820 via a memory-based communication channel established through shared memory regions of a shared memory maintained at ESMD 820. For example, COSM defined information 803 indicates: (1) transactions control; (2) permissions; (3) memory management; and (4) control functions for memory transactions for this established memory-based communication channel. Item (1) related to transaction control can be related to data inspection and policy enforcement that may be implemented in a similar manner as mentioned above for isolation scheme 400 (COSM isolation level 402). Item (2) related to permissions may be implemented in a similar manner as mentioned above for isolation scheme 400 (COSM isolation level 401) and for permission matrix scheme 500. Item (3) related to memory management can result in host 810 sharing memory regions 1-4 with host 820 and also can result in host 820 having exclusive access to memory region M. Item (4) related to control functions for memory transactions can also be related to data inspection and policy enforcement implemented in a similar manner as mentioned above for isolation scheme 400 (COSM isolation level 402).

In some examples, hosts 810 and 820 can allocate their respective address space that map to shared memory regions 1-4 to applications included in application(s) 811 and 813. For example, host 810 and host 830 address spaces that include memory regions k, l, m, n are mapped to shared memory regions 1-4. Also, host 830's address space q is shown in FIG. 8 as mapping to memory region M that is not shared between hosts 810 and 830. Application A of host 810 can request and receive an allocation of memory region k and l that maps to shared memory region 1 and 2.

Similarly, application A of host 830 can request and receive an allocation of memory region k and l that also maps to shared memory regions 1 and 2. Also, application B of host 830 can request and receive an allocation of memory region q that maps to memory region M.

According to some examples, data transfers through shared memory regions 1-4 can be conducted with user defined protocol data units (UPDUs). For these examples, applications can determine a data structure to be used for sharing over shared memory regions 0-4. This can allow applications to create UPDUs over the shared memory, whereby applications can define data block specifications, such as data type, block size, and headers. As shown in FIG. 8 for data transfer scheme 800, application defined information item (1) data type, block size, headers can indicate how data block specifications are defined. Also, item (2) can define transaction types (e.g., read/write), item (3) can define a buffer type to use at an ESMD with COSM, and item (4) can define a flow control.

According to some examples, as shown in FIG. 8A, shared memory 825 includes in-memory compute circuitry 824. In-memory compute circuitry 824 can be capable of executing sensitive computations within memory buffers maintained in at least a portion of the memory regions maintained in shared memory 825. Similar to the memory buffers mentioned above for FIG. 4, these memory buffers can have a self-destructive capability that automatically erases data associated with the computations executed by in-memory compute circuitry 824. This self-destructive capability can prevent persistence of data associated with the computations executed by the in-memory compute circuitry 824 and can prevent or reduce a risk of an unauthorized retrieval of this data.

For example, administrator 850-0 such as RAN manager (e.g., SMO, RIC, or operator) can configure COSM control plane unit 832 with a COSM service setup request for isolation among network functions and edge/cloud applications executed for operator A. Similarly, administrator 850-1 such as RAN manager (e.g., SMO, RIC, or operator) can configure COSM control plane unit 832 with a COSM service setup request for isolation among network functions and edge/cloud applications executed for operator B.

Administrator 850-0 and/or 850-1 can configure control plane 832 and/or orchestrator 840 with a service level agreement (SLA) or service level objective (SLO) for memory and compute resources utilized for a communication channel between applications 811 and 831 using ESMD with COSM 820. An SLA or SLO can specify at least one or more of: allocated memory bandwidth, allocated memory, allocated storage bandwidth, allocated storage, allocated network interface device bandwidth, allocated number of cores, processor utilization percentage, processor operating frequency, system uptime, number of generated frames per second (FPS), number of operations performed per second (OPS), or other criteria.

For example, for operator A, host 810 can execute applications 811 that can perform network functions and edge/cloud applications such as ORAN components or NextG core functions. For example, for operator B, host 830 can execute applications 831 that can perform network functions and edge/cloud applications such as ORAN components or NextG core functions.

In some examples, administrator 850-0 or administrator 850-1 can configure end-to-end isolation of communications for a network slice or between network functions by specification of a policy configuration request to interface with control plane 832 and orchestration 840. A policy configuration request can be expressed in JavaScript Object Notation (JSON), YAML Ain't Markup Language (YAML), or gRPC-based schema. An example policy configuration request can be as follows.

```
PolicyConfigRequest
{
  “policy_id”: “string”,
  “flow_id”: “string”,
  “tenant_id”: “string”,
  “source_domain”: “Client | RAN | Core | Edge”,
  “destination_domain”: “Client | RAN | Core | Edge”,
  “resource_type”: [“Memory”, “Compute”, “Network”],
  “resource_size”: {
  “memory_MB”: “int”,
  “compute_cores”: “int”,
  “bandwidth_Mbps”: “int”
  },
  “priority”: “High | Medium | Low”,
  “duration_sec”: “int”,
  “isolation_level”: “Strict | Moderate | Shared”,
  “security_classificat ion”: “Sensitive | Non-sensitive”,
  “cosm_binding_policy”: {
  “write_access”: [“host_id_1”],
  “read_access”: [“host_id_2”, “host_id_3”],
  “access_control_ttl”: “int”
  },
  “telemetry_required”: true,
  “logging”: {
  “enable_audit”: true,
  “log_level”: “info | debug | warning”
  }
}
```

For example, resource_type can specify one or more of memory, compute, or networking resources to exclusively allocate to an isolated communications channel. For example, isolation_level can specify an isolation level of strict, moderate, or low. For example, an isolation level of strict can allocate memory addresses or memory devices and compute devices exclusively to an operator. For example, an isolation level of moderate can allocate memory addresses or memory devices and compute devices exclusively to an operator for a particular time or operation, such as connection setup. For example, an isolation level of shared can share memory addresses or memory devices and compute devices among operators.

For example, write_access can specify which host is permitted to write to a memory region. For example, read_access can specify which host is permitted to read from a memory region.

For example, telemetry_required can specify whether the ESMD with COSM is to report telemetry data such as memory addresses read from, memory addresses written to, number of memory reads or writes for a particular range of memory addresses, processor utilization or busyness, accelerator utilization or busyness, networking utilization or busyness, or others.

For example, log_level can specify that telemetry can be reported as information (info), a subset of information that is debug-related, or a warning of resources being overutilized, underutilized, or memory addresses being requested to be accessed by an application that is not granted permission to access the memory addresses.

FIG. 8B depicts an example system. The framework provides hardware-enforced isolation, allowing multiple operators to securely share a common Remote Radio Head (RRH) and Distributed Unit (DU) and while maintaining strict separation between data shared between the DU and operator-specific Control Units (CUs) and 5G Core network function. In some examples, an untrusted ORAN can be utilized whereby a DU shares data with a CU and 5G Core network function but does not utilize COSM to isolate data from CU or 5G core network functions of other operators or tenants.

3GPP split sub-option 7.2, defined at least in 3GPP Release 15, describes vertical RAN splits, where distinct network functions such as Control Plane (CP), User Plane (UP), and Distributed Units (DU) are segmented across the regional cloud, edge cloud, and cellular site. Vertical RAN split occurs across protocols (e.g., between PHY, MAC, RLC, PDCP, RRC, or others). Protocols can operate independently, leading to redundant data exchange across slices. While Vertical RAN split enables distribution of network functions, making it susceptible to cross-tenant interference or data leakage in multi-operator scenarios. Isolation between network slices can occur while maintaining communication between among RAN components.

As described herein, horizontal RAN split enables multiple slices to communicate using transactional memory, e.g., Controlled Shared Memory (COSM). By integrating COSM transactional memory, the horizontal split architecture can provide multi-slice operations with isolated data. According to horizontal RAN split, a network function (e.g., CU-UP or DU) can be split across multiple hardware isolation domains, allowing slices to run on physically or logically separated memory and compute. These domains communicate through COSM-managed transactional memory where access is controlled via a permission matrix, providing robust isolation.

FIG. 8C depicts an example system. In the horizontal RAN split architecture, control and user plane functions can be separated per slice and deployed in isolation using COSM infrastructure. Unlike the rigid allocation of vertical splits, memory resources in COSM can be dynamically allocated based on slice demand and can reduce over-provisioning and enhance slice flexibility. Near-RT RIC (Real-Time RAN Intelligence Control) can enforce slice-specific memory policies in COSM. O-CU (Control/User Plane Functions) can manage real-time memory transactions between network slices in COSM. O-DU (Distributed Unit) and O-RU (Radio Unit) can operate under COSM-controlled memory partitions, ensuring isolation and data integrity.

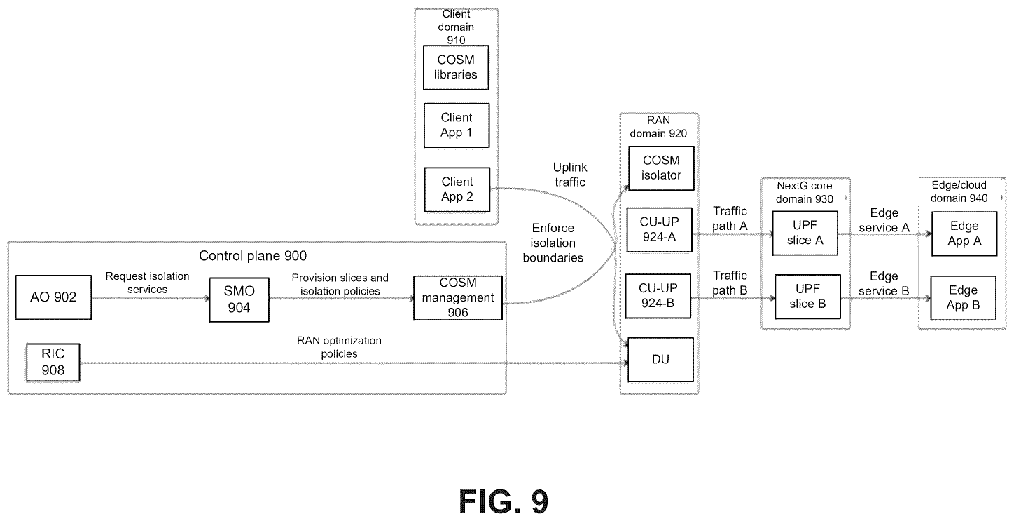

FIG. 9 depicts an example system. In control plane 900, application orchestrator (AO) 902 can manage customer requests for isolation services for tenants A and B. In control plane 900, System Management and Operations (SMO) 904 can perform network slice and resource provisioning in COSM management 906. For example, network slice and resource provisioning can include allocation of memory and compute resources to tenants A and B.

In client domain 910, client application 1 for tenant A can transmit traffic to a 5G network for processing by DU 922 and by CU-UP 924-A (CU for uplink communications) with traffic isolation for tenant A in COSM as configured by COSM management 906. Also using traffic isolation for tenant A in COSM, traffic for tenant A can be processed by UPF slice A in NextG core domain 930 and by edge service A in edge/cloud domain 940.

In control plane 900, Radio Intelligent Controller (RIC) 908 can adjust memory and compute resources for tenant A based on telemetry, as described herein. For example, RIC 908 can dynamically adjust allocated memory devices, allocated memory addresses, memory bandwidth, compute devices, and based on real-time workload and security policies.

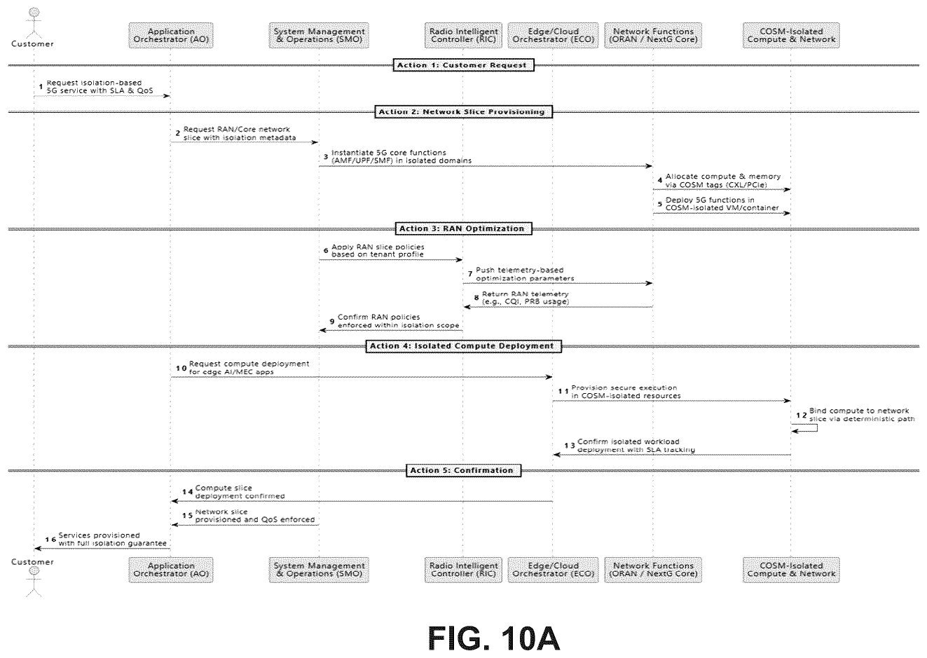

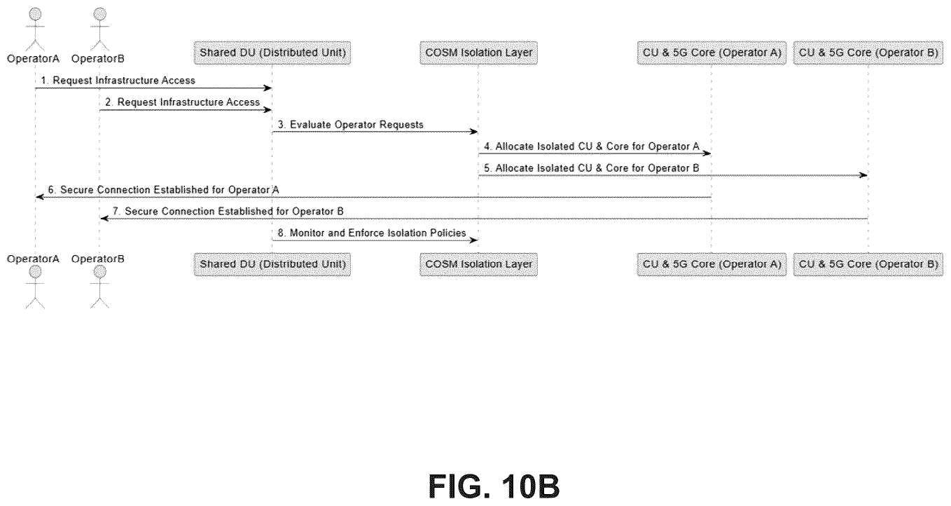

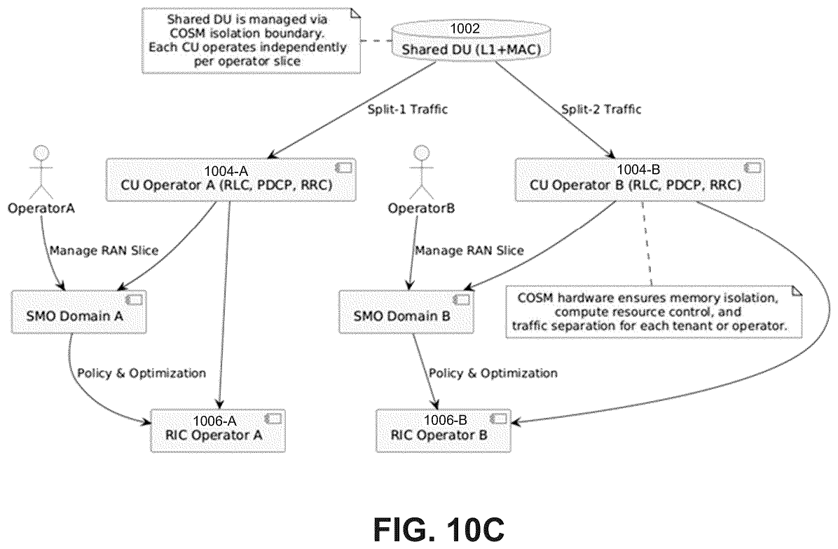

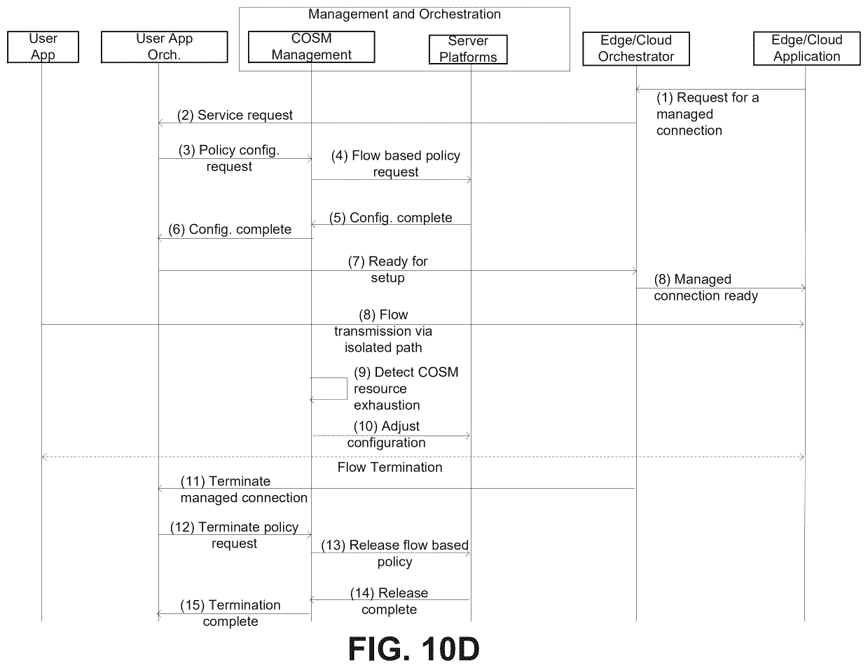

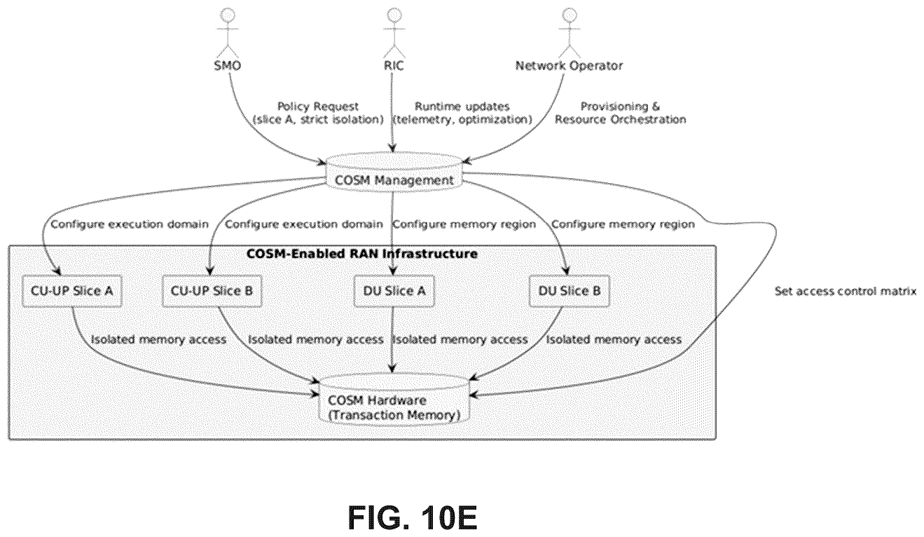

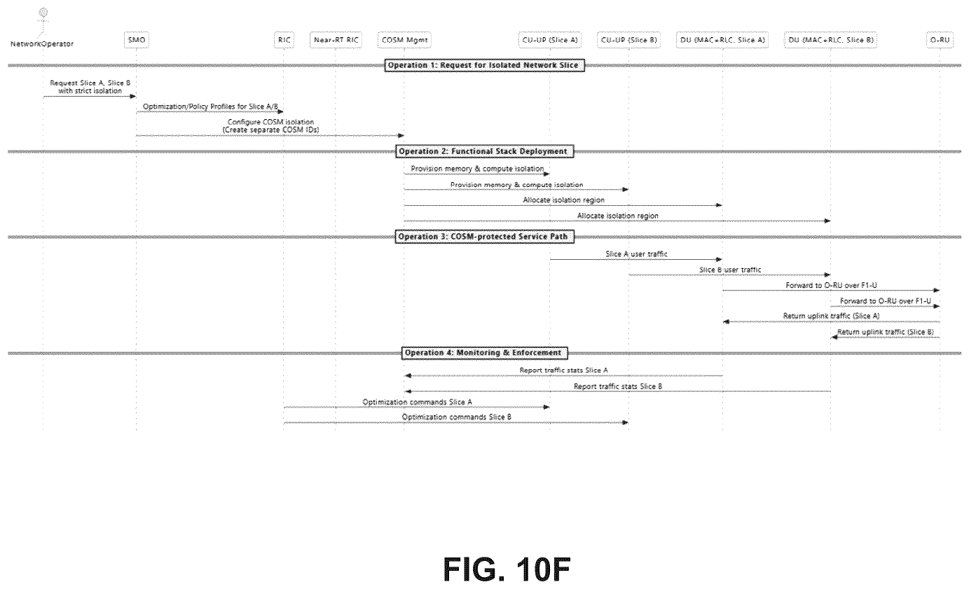

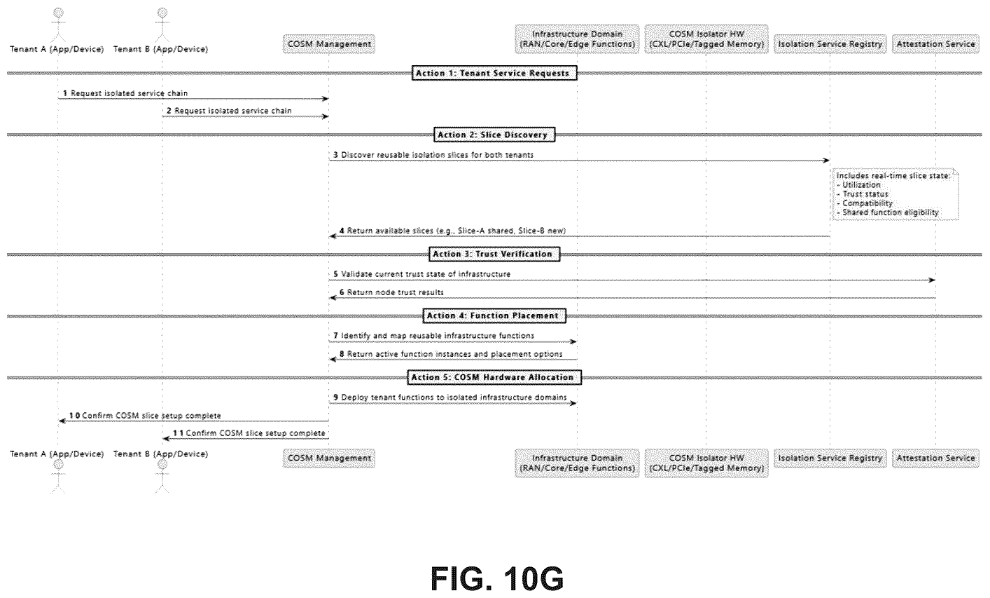

FIG. 10A depicts an example flow diagram for multiple operators to share the common infrastructure. At (1), a customer (e.g., operator or tenant) can request application orchestrator to provide isolated 5G or 5GC services for the customer. At (2), the application orchestrator (AO) can request system management and operations (SMO) to allocate resource for a network slice by specifying isolation configuration. Various examples of isolation configuration can include specification of strict, medium or low level of isolation as well as indication of whether to supply telemetry data and adjust resource allocation or other examples described herein.

From (3)-(5), System Management and Operations (SMO) can instantiate core network functions (e.g., UPF, AMF, SMF, or others) in isolated memory and compute domains. In 5GC, User Plane Function (UPF) processes user plane traffic by routing and data forwarding between the user equipment (UE) and external data networks. UPF can perform packet processing and traffic aggregation, Radio Access Network (RAN)/Data Network (DN) interconnect, packet inspection and application detection, packet routing and data forwarding, Quality of Service (QOS) management and usage reporting, traffic anchoring for UE IP addresses, or others.

Access and Mobility Management Function (AMF) is an entry point for user equipment (UE) connections. AMF can handle connections and mobility management tasks; manage UE registration, authentication, and authorization; track device location and manages handovers; enforce network policies such as QoS and charging; coordinate with the Session Management Function (SMF) to establish and manage user sessions; enable different virtualized network segments for specific use cases; Next Generation Application Protocol (NGAP) service user and provider for communicating with the RAN for access and mobility management; handle fault management within the 5GC; or others.

At (6), SMO can configure RIC with RAN slice telemetry reporting policies based on tenant profiles. At (7), RIT can configure core network functions to report particular telemetry parameters. Telemetry parameters can include Channel Quality Indicator (CQI) can indicate a quality of radio link and can be used to change modulation and encoding scheme, Physical Resource Block (PRB) that indicates utilized available radio resources, memory addresses that were read-from, memory addresses that were written-to, or others. At (8), core network functions can report telemetry to RIC. At (9), RIC can confirm to SMO that telemetry reporting has occurred and the telemetry supports isolation. Based on reported telemetry, SMO can adjust memory and computing resources allocated for network slices. For example, telemetry can indicate read and writes to memory addresses in an isolated region. Based on read and writes to memory addresses in isolated region, isolation can be confirmed. However, if read and writes are to memory addresses outside isolated region, no isolation can be indicated and the SMO can change a COSM device utilized to provide isolated communications for a tenant or customer or change the memory addresses allocated to provide isolated communications for a tenant or customer.

At (10), AO can request edge cloud orchestrator (ECO) to deploy AI/MEC applications. Edge/Cloud Orchestrator (ECO) can deploy isolated compute workloads in allocated processors and memory. For example, compute workloads can include Network Functions (e.g., ORAN CU, DU, or Radio Intelligent Controller (RIC) or 5GC UPF, AMF, or others) that implements 5G Core Network (5GC) services within COSM-isolated resources. The ECO can provision edge compute workloads within COSM-isolated environments, allowing secure execution of latency-sensitive applications.

At (11) and (12), ECO can deploy Artificial Intelligence (AI) and Multi-access Edge Computing (MEC) applications to be utilized by network functions in isolated memory and compute domains. AI/MEC applications can be deployed in COSM to isolate data for a slice. At (13), isolated memory and compute domains can confirm deployment of AI/MEC applications.

At (14), ECO confirm compute slice deployment to AO. At (15), SMO can confirm to AO that network slice is provisioned and QoS is enforced. At (16), AO can indicate to the user that services are provisioned with compute and memory isolation.

FIG. 10B depicts an example sequence of operations. At (1), operator A can request infrastructure access to a shared DU. At (2), operator B can request infrastructure access to the shared DU. While examples are described with respect to operators, an operator can instead be a tenant. At (3), shared DU can indicate to isolated memory and compute that operators A and B are sharing DU. At (4), isolated memory and compute for a CU and 5GC network functions can be allocated for operator A. At (5), separate isolated memory and compute for a CU and 5GC network functions can be allocated for operator B.

At (6), CU and 5GC network functions for operator A can indicate to operator A that a secure connection was established between the shared DU and isolated CU. At (7), CU and 5GC network functions for operator B can indicate to operator B that a secure connection was established between the shared DU and isolated CU. Thereafter, packet traffic for operators A and B can traverse shared DU but are processed by isolated CU for operators A and B.

At (8), the shared DU can monitor and enforce isolation. Based on read and writes to memory addresses in isolated region, isolation can be confirmed. However, if read and writes are to memory addresses outside isolated region, no isolation can be indicated for an operator and enforcement of isolation can occur by expanding an allocated region of memory and increasing compute device (e.g., accelerator, central processing unit, graphics processing unit, or other circuitry) or allocating a different region of memory and different compute device to traffic of the operator.

FIG. 10C depicts an example system. Shared DU 1002 can process packets for operators A and B. In a multi-tenant Open RAN (ORAN) environment, DU 1002 serves as a shared compute and radio resource across multiple operators. DU sharing enables infrastructure providers or hosts to host multiple operators' workloads, thus reducing deployment costs and optimizing spectrum usage. Controlled shared memory technology provides a hardware isolation that splits traffic at DU 1002 and directs traffic to logically and physically isolated centralized units (CUs) for each operator. Traffic splitting at DU 1002 can enforce flow-specific policies. Based on subscriber profiles or access point names (APNs), user traffic can be directed through specific slices or CU instances of the operator. COSM confines data flows to designated isolation zones to reduce the risk of data leakage or interference across operator domains. Even though the DU is a shared resource, the data and control path integrity can be maintained using programmable, runtime-enforced COSM isolation boundaries. While examples are described with respect to operators, an operator can instead be a tenant.

Compute and memory resources for operator A can be isolated from compute and memory resources for operator B. CU 1004-A for operator A can process packets for operator A from DU 1002 whereas CU 1004-B for operator B can process packets for operator B from DU 1002. RIC 1006-A for operator A can process packets for operator A from CU 1004-A whereas RIC 1006-A for operator B can process packets for operator B from CU 1004-B. Different operators can utilize operator-specific SMO and RIC managing CU independently for secure control over respective slices. Control plane and user plane functions cannot cross operator boundaries without explicit permission.

FIG. 10D depicts an example sequence. At (1), edge or cloud application can request user application orchestrator to provide a managed connection for communication with a user application. For example, edge or cloud application can include a 5G ORAN or 5GC network function. At (2), edge and cloud orchestrator (ECO) can request a flow-based policy configuration to user application orchestrator for memory and compute resources. A flow-based policy request can specify at least: a flow identifier, demand information, service level agreement (SLA), duration, or others. The following is an example of fields of a configuration request. This configuration allows the SMO to orchestrate an end-to-end service path with guaranteed isolation, using COSM hardware primitives and software hooks exposed to RIC, DU, CU, and Edge orchestrators.

| Field | Example description |
|---|---|
| sliceId | Unique identifier for the network slice. |
| operatorId | Refers to the operator requesting the slice. |
| isolationLevel | Degree of COSM enforcement required (e.g., High, Medium, |
| | None). |
| cosmDomain | Contains the hardware-level configuration managed by COSM |
| | isolator (e.g., memory regions, CPU cores). |
| isolationBoundaries | Dictates which compute domains can access what-enforced by |
| | the COSM permission matrix. |
| xappProfiles | Specifies optimization modules deployed in the RIC (e.g., AI- |
| | based steering). |
| APN & QoS | Used to configure end-to-end flow to external services or |
| | application endpoints. |

```
{
  “sliceRequest”: {
  “sliceId”: “Slice-A1”,
  “operatorId”: “OperatorA”,
  “useCase”: “SmartManufacturing”,
  “isolationLevel”: “High”,
  “sliceType”: “eMBB”,
  “trafficProfile”: {
    “latency”: “10ms”,
    “throughput”: “1Gbps”,
    “reliability”: “99.999%”
  },
  “resourceAllocation”: {
    “duId”: “SharedDU01”,
    “cuId”: “CU_A”,
    “cosmDomain”: {
    “memoryRegion”: “Region01”,
    “cpuCores”: [2, 3],
    “xpuEnabled”: true,
    “isolationBoundaries”: {
      “enabled”: true,
      “permissionMatrix”: {
      “CU_A”: [“read”, “write”],
      “CU_B”: [ ]
      }
    }
    }
  },
  “controlPlane”: {
    “smoId”: “SMO_A”,
    “ricId”: “RIC_A”,
    “xappProfiles”: [“TrafficSteering”, “LoadBalancing”]
  },
  “dataPlane”: {
    “apn”: “smart-manufacturing.apn”,
    “routingEndpoint”: “10.1.1.10”,
    “qos”: “QCI-5”
  },
  “lifecycleManagement”: {
    “activationTime”: “2025-06-01T00:00:00Z”,
    “deactivationTime”: “2028-06-01T00:00:00Z”
  }
  }
}
```

Various examples of configuration requests are as follows.

### Example 1: Isolated Video Stream Processing (Sensitive)

A camera feed in a smart city setup is routed and processed on an isolated edge node.

```
{
  “policy_id”: “pol-vid-sec-001”,
  “flow_id”: “flow-cam-9001”,
  “tenant_id”: “city-surveillance”,
  “source_domain”: “Client”,
  “destination_domain”: “Edge”,
  “resource_type”: [“Memory”, “Compute”, “Network”],
  “resource_size”: {
  “memory_MB”: 512,
  “compute_cores”: 2,
  “bandwidth_Mbps”: 100
  },
  “priority”: “High”,
  “duration_sec”: 3600,
  “isolation_level”: “Strict”,
  “security_classification”: “Sensitive”,
  “cosm_binding_policy”: {
  “write_access”: [“cam-host-001”],
  “read_access”: [“edge-host-vidproc”],
  “access_control_ttl”: 3600
  },
  “telemetry_required”: true,
  “logging”: {
  “enable_audit”: true,
  “log_level”: “info”
  }
}
```

### Example 2: Shared Data Analytics Flow (Non-Sensitive)

An analytics workload analyzing anonymized retail data across multiple tenants using a shared COSM domain.

```
{
  “policy_id”: “pol-analytics-002”,
  “flow_id”: “flow-retail-metrics”,
  “tenant_id”: “retail-consortium”,
  “source_domain”: “Edge”,
  “destination_domain”: “Core”,
  “resource_type”: [“Memory”, “Network”],
  “resource_size”: {
  “memory_MB”: 1024,
  “compute_cores”: 1,
  “bandwidth_Mbps”: 50
  },
  “priority”: “Medium”,
  “duration_sec”: 7200,
  “isolation_level”: “Shared”,
  “security_classification”: “Non-sensitive”,
  “cosm_binding_policy”: {
  “write_access”: [“edge-collector”],
  “read_access”: [“core-analyzer”, “partner-dashboard”],
  “access_control_ttl”: 7200
  },
  “telemetry_required”: false,
  “logging”: {
  “enable_audit”: false,
  “log_level”: “warning”
  }
}
```

At (3), user application orchestrator can request a flow-based policy configuration to COSM management of an orchestrator. At (4), COSM management can issue a request for memory and compute isolation in resources of a server platform (e.g., host). Server platform can include a memory device, accelerator, processor, storage, memory, or other circuitry or software. Memory and compute isolation provides for network function data isolation, preventing cross-tenant interference. Memory device has a finite set of memory regions and compute binding capabilities, determined by hardware limitations such as: number of isolated memory pools, maximum concurrent flows per domain, total bandwidth allocation, input/output (I/O) channel limits. At (5) and (6), server platform (e.g., host) can inform user application orchestrator that the configuration has been deployed.

At (7), user application orchestrator can inform ECO that a configuration is ready for a communication between a user application and edge or cloud application. At (8), ECO can indicate to edge or cloud application that an isolated connection that complies with the ECO's policy is available. At (8), user application can transmit packets and traffic via the managed connection to edge or cloud application via the isolated connection.

At (9), COSM Management and Orchestration can monitor memory and compute utilization of server platforms in real-time and map flow policies to isolation boundaries (defined by application SLAs). For example, at (10), COSM Management and Orchestration can adjust an allocation of resources for the communication between the user application and the edge or cloud application. If compute or memory resources become exhausted or do not provide isolation or meet SLA parameters or QoS, dynamic reallocation of compute or memory resources can occur based on orchestration preferences and available resources. Resource exhaustion can occur based on: all memory regions of the memory device being bound to ongoing flows, read/write access rates per host exceed permissible levels, permission matrix becomes saturated and limits new policy entries, or others. Based on detection of hardware resource exhaustion, COSM management can evaluate possible fallback actions, such as: increasing an amount of allocated memory for the isolated connection, increasing deployed compute resources for the isolated connection, redirecting flows to secondary COSM instances, releasing non-critical flows based on expiration or policy weight, sending alerts to application orchestrators for resource reallocation, or others.

COSM management and orchestration can evaluate the priority of flows, based on: user or tenant priority levels, application criticality (e.g., emergency or non-emergency video analytics), data sensitivity and compliance needs, or SLA performance (latency, jitter, throughput). For example, a flow of data for a network function can be re-allocated from strict to medium or shared for a temporary time amount. For example, additional compute or memory resources can be allocated to the network function. In some examples, the network function can be migrated to execute on a different host or processor and utilize a different memory device. COSM management is notified to prevent further flow initialization and possibly to reassign or evict existing flows based on priority. Orchestration systems can switch flows between isolated domains, migrate application components (e.g., microservices) to other compute zones, or otherwise adjust memory and compute resources allocated to network functions and hardware pools.

At (11), based on flow termination, ECO indicates to user application orchestrator to release the allocated resources. At (12), user application orchestrator can indicate to COSM management to terminate an active policy request for communication between the user application and the edge or cloud application. At (13), COSM management can release resources in server platforms. At (14), server platforms can indicate the release is complete. At (15), COSM management can indicate to user application orchestrator that termination is complete of the isolated resource connection between the user application and the edge or cloud application.

FIG. 10E depicts an example of horizontal RAN splits. A network operator can request COSM management (e.g., ESMD) to provide separation of resources for multiple network slices for tenants A and B. Service Management and Orchestration (SMO) can communicate with the RAN Intelligent Controller (RIC) to generate slice-specific profiles and policies and instruct the COSM management system to instantiate isolated compute and memory domains for Central Unit (CU) and Distributed Unit (DU) of the slices A and B to instantiate horizontal RAN split. COSM hardware (e.g., ESMD) can provision isolated execution environments for network slices A and B by assigning independent memory and compute allocations to CU and DU for slices A and B. For example, the CU and DU components for slice A can be deployed on separate COSM-managed domains from the CU and DU components of slice B to reduce data leakage between slices and process the traffic independently. The user traffic corresponding to slice A can be accessible to CU and DU instances for slice A for processing, whereas user traffic corresponding to slice B can be accessible to CU and DU instances for slice B for processing.

FIG. 10F depicts an example of events. In operation (1), an SMO can configure a shared memory device to provide communications among network functions (e.g., CU, DU, or others) of one or more slices. COSM Management system orchestrates secure memory and compute isolation so that a slice, comprising CU-UP and DU components, is provisioned with its own execution and memory domains via COSM Hardware that operates on a transactional memory model. The COSM Management system sets access control policies and permission matrices for these components, ensuring that each slice's data path and compute space are strictly isolated. A network operator requests System Management and Operations (SMO) to provide resource allocation and communications among network functions of slice A using a shared memory device. For example, a network operator requests SMO to provide resource allocation and communications among network functions of slice B using a shared memory device. SMO can provide a policy profile for slices A and B to Radio Intelligent Controller (RIC) to provide isolated memory-based communication among network functions of slice A. In turn, SMO can configure shared memory device to provide isolated memory-based communication among network functions of slice B.

In operation (2), COSM management can configure isolation among data communicated among network functions of a slice A and slice B. For slice A, COSM management can configure memory and compute for CU-CP, CU-UP, and DU isolated from another slice (e.g., slice B). For slice B, COSM management can configure memory and compute for CU-CP, CU-UP, and DU isolated from another slice (e.g., slice A).

In operation (3), CU-UP can communicate traffic to a DU in a corresponding slice via isolated memory. For example, for slice A, CU-UP can communicate traffic to a DU via isolated memory. For example, for slice A, DU can communicate traffic to a O-RU via an isolated memory (F1-U). For example, for slice B, CU-UP can communicate traffic to a DU. For example, for slice B, DU can communicate traffic to a O-RU via an isolated memory (F1-U). For slice A, O-RU can provide uplink traffic to DU via the isolated memory. For slice B, O-RU can provide uplink traffic to DU via the isolated memory.

In operation (4), resource allocation can be adjusted based on telemetry data. The architecture supports real-time runtime policy updates, performance monitoring, and slice-specific optimization through RIC and SMO collaboration at least for multi-tenant 5G deployments. For slice A, DU can provide traffic statistics such as memory addresses read from or written to, applications that read or write to the memory addresses, or memory bandwidth utilized to COSM management and RIC can selectively adjust resource allocation to the DU based on identifying that resources are over utilized or are not isolated. For example, RIC can adjust a memory device utilized for the communication to and from the DU, adjust memory addresses allocated for the data stored for communication to and from the DU, adjust computing resources allocated to the DU, or make other resource allocation adjustments. For slice B, DU can provide traffic statistics to COSM management and RIC can selectively adjust resource allocation for DU in a similar manner as described for slice A.

FIG. 10G depicts an example sequence of events to utilize an instantiated and executing network function. Action (1) can include tenants requesting deployment of an isolated service chain. For example, tenant A can request COSM management to cause execution of multiple network functions that communicate using memory and compute resources isolated for tenant A. For example, tenant B can request COSM management to cause execution of multiple network functions that communicate using memory and compute resources isolated for tenant B. Tenants can specify operations to be performed by the service chain as well as level of isolation for communications between network functions. For example, tenant A can specify a first network function is to perform DU and a second network function is to perform a CU and that communications of data between the DU and CU are to utilize isolated memory and compute resources. For example, tenant B can specify a first network function is to perform CU and a second network function is to perform a UPF and that communications of data between the CU and UPF are to utilize isolated memory and compute resources.

Action (2) can include discovery of previously installed and deployed network functions that is executing on or assigned to execute on a processor, has at least one memory region allocated, and that provides operations requested by tenant A. For example, for deployed network functions, COSM management can request an isolation service registry in a control plane or COSM to identify configuration parameters of existing network functions, such as memory and compute resource utilization, trust status (e.g., strict isolation, medium isolation, no isolation), compatibility and shared function eligibility with other network functions of the requested service chain. The isolation service registry can report the configuration parameters of existing network functions to COSM management.

Action (3) can include verifying a current trust state of the deployed network functions. For example, COSM management can request and verify a current trust state of the isolated memory and compute resources (e.g., strict isolation, medium isolation, no isolation). For example, isolated memory and compute resources can utilize a hardware root of trust (RoT), firmware, or operating system (OS) that can verify configuration parameters of deployed network functions.

Action (4) can include determining available network functions that meet the configuration parameters. For example, COSM management can request identification of the network functions that are deployed on isolated compute and memory resources that meet the configuration parameters.

Action (5) can include binding resources for the deployed service chain to the isolated compute and memory resources that meet the configuration parameters. For example, if tenant A requests shared resources (no isolation) for its service chain, previously deployed network functions that do not use isolated memory or compute resources can be utilized to perform network functions of the service chain for tenant A. For example, if tenant B requests isolation for its service chain, previously deployed network functions that use isolated memory or compute resources can be utilized to perform network functions of the service chain for tenant B. COSM management can utilize the network functions for tenants A and B in the selected resources. In some examples, if no previously deployed network function meets the configuration parameters, COSM management can also instantiate and deploy a network function on resources that meet the configuration parameters. COSM management can confirm to tenants A and B that the network functions of the service chains have been deployed.

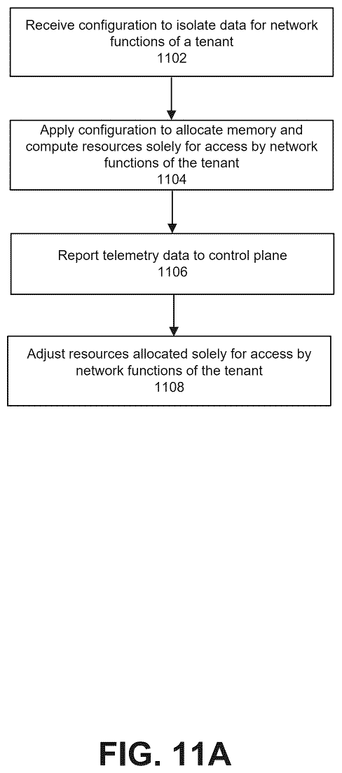

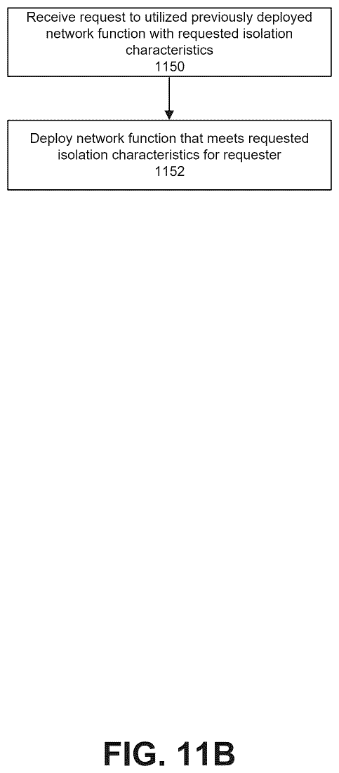

FIG. 11A depicts an example process. The process can be performed by a memory device that can restrict reads and writes to memory addresses in memory based on a requesting network function. Various examples of network functions are described herein. At 1102, a configuration to isolate data for network functions can be received by the memory device. For example, the configuration can be received from a control plane. The configuration can specify at least a level of isolation (e.g., high, medium, none), size of memory addresses to allocate, number of processor cores and accelerators resources to allocate, or others. At 1104, the memory device can apply the configuration to allocate the requested memory and compute to the network function. At 1106, the memory device can report telemetry data to the control plane. The telemetry data can be indicative of accesses to memory regions, memory bandwidth utilized, processor resources utilized, or other telemetry. At 1108, based on a received request, the memory device can adjust memory and compute resources allocated to the network function as described herein.

FIG. 11B depicts an example process. At 1150, an orchestrator can receive a request to utilize a deployed network function with particular isolation characteristics. For example, a deployed network function can include a deployed 5G or 5GC function such as DU, CU, UPF, AI/MEC application, or others. For example, particular isolation characteristics can include isolated, medium, or no isolation. At 1152, the deployed network function that meets or exceeds specified isolation characteristics can be utilized, without redeploying the network function or instantiating the network function, to perform operations for the requester. For example, a tenant or operator can request reuse of the executed network function that communicates to another network function using reserved memory regions. However, if no deployed network function has isolation characteristics that meet or exceed specified isolation characteristics, an orchestrator can deploy another network function using shared reserved memory and compute resources that meet or exceeds specified isolation characteristics.

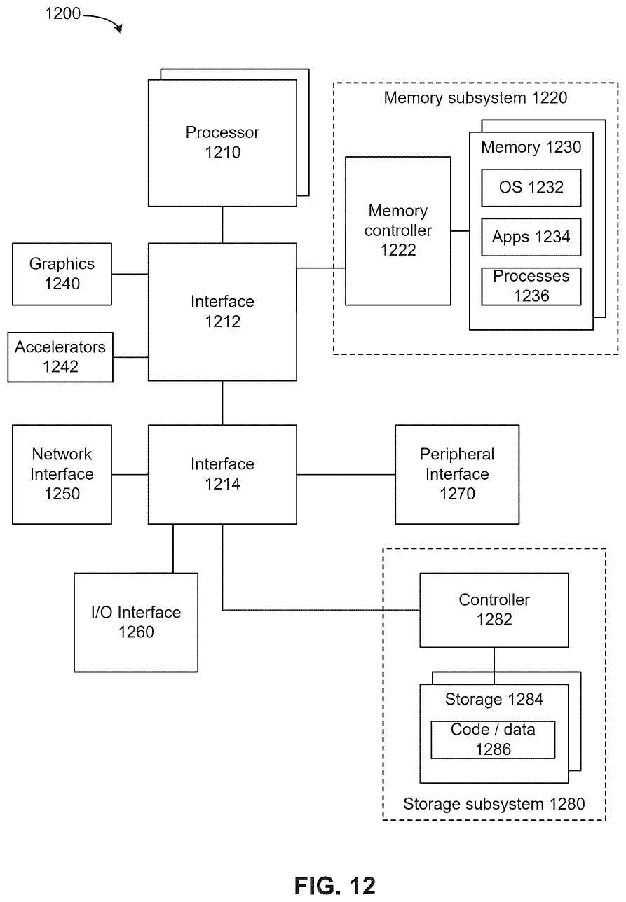

FIG. 12 depicts a system. In some examples, circuitry of system 1200 can be used to execute network functions, orchestration, or control plane software, as described herein. System 1200 includes processor 1210, which provides processing, operation management, and execution of instructions for system 1200. Processor 1210 can include any type of microprocessor, central processing unit (CPU), graphics processing unit (GPU), XPU, processing core, or other processing hardware to provide processing for system 1200, or a combination of processors. An XPU can include one or more of: a CPU, a graphics processing unit (GPU), general purpose GPU (GPGPU), and/or other processing units (e.g., accelerators or programmable or fixed function FPGAs). Processor 1210 controls the overall operation of system 1200, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1200 includes interface 1212 coupled to processor 1210, which can represent a higher speed interface or a high throughput interface for system components that needs higher bandwidth connections, such as memory subsystem 1220 or graphics interface components 1240, or accelerators 1242. Interface 1212 represents an interface circuit, which can be a standalone component or integrated onto a processor die. Where present, graphics interface 1240 interfaces to graphics components for providing a visual display to a user of system 1200. In one example, graphics interface 1240 generates a display based on data stored in memory 1230 or based on operations executed by processor 1210 or both. In one example, graphics interface 1240 generates a display based on data stored in memory 1230 or based on operations executed by processor 1210 or both.

Accelerators 1242 can be a programmable or fixed function offload engine that can be accessed or used by a processor 1210. For example, an accelerator among accelerators 1242 can provide data compression (DC) capability, cryptography services such as public key encryption (PKE), cipher, hash/authentication capabilities, decryption, or other capabilities or services. In some cases, accelerators 1242 can be integrated into a CPU socket (e.g., a connector to a motherboard or circuit board that includes a CPU and provides an electrical interface with the CPU). For example, accelerators 1242 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1242 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1220 represents the main memory of system 1200 and provides storage for code to be executed by processor 1210, or data values to be used in executing a routine. Memory subsystem 1220 can include one or more memory devices 1230 such as read-only memory (ROM), flash memory, one or more varieties of random access memory (RAM) such as DRAM, or other memory devices, or a combination of such devices. Memory 1230 stores and hosts, among other things, operating system (OS) 1232 to provide a software platform for execution of instructions in system 1200. Additionally, applications 1234 can execute on the software platform of OS 1232 from memory 1230. Applications 1234 represent programs that have their own operational logic to perform execution of one or more functions. Processes 1236 represent agents or routines that provide auxiliary functions to OS 1232 or one or more applications 1234 or a combination. OS 1232, applications 1234, and processes 1236 provide software logic to provide functions for system 1200. In one example, memory subsystem 1220 includes memory controller 1222, which is a memory controller to generate and issue commands to memory 1230. It will be understood that memory controller 1222 could be a physical part of processor 1210 or a physical part of interface 1212. For example, memory controller 1222 can be an integrated memory controller, integrated onto a circuit with processor 1210.

Applications 1234 and/or processes 1236 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1232 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 1200 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1200 includes interface 1214, which can be coupled to interface 1212. In one example, interface 1214 represents an interface circuit, which can include standalone components and integrated circuitry. In one example, multiple user interface components or peripheral components, or both, couple to interface 1214. Network interface 1250 provides system 1200 the ability to communicate with remote devices (e.g., servers or other computing devices) over one or more networks. Network interface 1250 can include an Ethernet adapter, wireless interconnection components, cellular network interconnection components, USB (universal serial bus), or other wired or wireless standards-based or proprietary interfaces. Network interface 1250 can transmit data to a device that is in the same data center or rack or a remote device, which can include sending data stored in memory. Network interface 1250 can receive data from a remote device, which can include storing received data into memory. In some examples, packet processing device or network interface device 1250 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 1200 includes one or more input/output (I/O) interface(s) 1260. I/O interface 1260 can include one or more interface components through which a user interacts with system 1200. Peripheral interface 1270 can include any hardware interface not specifically mentioned above. Peripherals refer generally to devices that connect dependently to system 1200.

In one example, system 1200 includes storage subsystem 1280 to store data in a nonvolatile manner. In one example, in certain system implementations, at least certain components of storage 1280 can overlap with components of memory subsystem 1220. Storage subsystem 1280 includes storage device(s) 1284, which can be or include any conventional medium for storing large amounts of data in a nonvolatile manner, such as one or more magnetic, solid state, or optical based disks, or a combination. Storage 1284 holds code or instructions and data 1286 in a persistent state (e.g., the value is retained despite interruption of power to system 1200). Storage 1284 can be generically considered to be a “memory,” although memory 1230 is typically the executing or operating memory to provide instructions to processor 1210. Whereas storage 1284 is nonvolatile, memory 1230 can include volatile memory (e.g., the value or state of the data is indeterminate if power is interrupted to system 1200). In one example, storage subsystem 1280 includes controller 1282 to interface with storage 1284. In one example controller 1282 is a physical part of interface 1214 or processor 1210 or can include circuits or logic in both processor 1210 and interface 1214.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 1200 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

In an example, system 1200 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: an input/output (I/O) interface; circuitry coupled to the I/O interface, the circuitry configured to: based on receipt of a first request, allocate a first region of one or more memory regions of a memory to store data reserved for access by a first network function, wherein the first network function comprises an Open Radio Access Network (ORAN) Control Unit (CU) of a radio access network (RAN) and wherein an ORAN Distributed Unit (DU) is to provide the data and based on receipt of a second request, allocate a second region of one or more memory regions of the memory to store second data reserved for access by a second network function, wherein the second network function comprises a second ORAN CU of the RAN, the DU is to provide the second data, and the DU is shared among the first CU and the second CU.

Example 2 includes one or more examples, wherein: the first request is to request isolation of a network slice for execution of the first network function.

Example 3 includes one or more examples, wherein: the first network function comprises a NextG User Plane Function (UPF) or Access and Mobility Management Function (AMF).

Example 4 includes one or more examples, wherein: the DU is to operate in a manner consistent with ORAN.

Example 5 includes one or more examples, wherein: the first network function is associated with a first tenant and the second network function is associated with a second tenant.

Example 6 includes one or more examples, wherein: the circuitry is configured to: based on receipt of a third request, allocate a third region of the one or more memory regions to store third data reserved for access by a first 5G Core network User Plane Function (UPF), wherein the DU is to provide the third data.

Example 7 includes one or more examples, wherein: the circuitry is configured to: based on receipt of a fourth request, allocate a third region of the one or more memory regions to store fourth data reserved for access by a second 5G Core network UPF, wherein the DU is to provide the fourth data and the DU is shared among the first UPF and the second UPF.

Example 8 includes one or more examples, wherein: the first network function is to provide a service consistent with 3rd Generation Partnership Project (3GPP) fifth-generation wireless technology (5G) Release 15 (2018) or 3GPP NextG Core (5GC) in Release 16 (2020).

Example 9 includes one or more examples, and includes at least one machine readable medium comprising a plurality of instructions that in response to being executed by a processor, cause the processor to: issue a first request to allocate a first region of one or more memory regions of the memory to store data reserved for access by a first network function, wherein the first network function comprises an Open Radio Access Network (ORAN) Control Unit (CU) of a radio access network (RAN) and wherein an ORAN Distributed Unit (DU) is to provide the data and issue a second request to allocate a second region of one or more memory regions of the memory to store second data reserved for access by a second network function, wherein the second network function comprises a second ORAN CU of the RAN, the DU is to provide the second data, and the DU is shared among the first CU and the second CU.

Example 10 includes one or more examples, wherein: the first request is to request isolation of a network slice for execution of the first network function.

Example 11 includes one or more examples, wherein: the first network function comprises a NextG User Plane Function (UPF) or Access and Mobility Management Function (AMF) and the DU is to operate in a manner consistent with ORAN.

Example 12 includes one or more examples, wherein: the first network function is associated with a first tenant and the second network function is associated with a second tenant.

Example 13 includes one or more examples, and includes a plurality of instructions that in response to being executed by a processor, cause the processor to: based on receipt of a third request, allocate a third region of the one or more memory regions to store third data reserved for access by a first 5G Core network User Plane Function (UPF), wherein the DU is to provide the third data and based on receipt of a fourth request, allocate a third region of the one or more memory regions to store fourth data reserved for access by a second 5G Core network UPF, wherein the DU is to provide the fourth data and the DU is shared among the first UPF and the second UPF.

Example 14 includes one or more examples, wherein: the first network function is to provide a service consistent with 3rd Generation Partnership Project (3GPP) fifth-generation wireless technology (5G) Release 15 (2018) or 3GPP NextG Core (5GC) in Release 16 (2020).

Example 15 includes one or more examples, and includes a method that includes: reserving a first region of one or more memory regions of the memory to store data from an Open Radio Access Network (ORAN) Distributed Unit (DU) for access by a first network function, wherein the first network function comprises an ORAN Control Unit (CU) of a radio access network (RAN) and reserving a second region of one or more memory regions of the memory to store second data from the ORAN DU for access by a second network function, wherein the second network function comprises a second ORAN CU of the RAN and wherein the DU is shared among the first CU and the second CU.

Example 16 includes one or more examples, wherein: the first network function comprises a NextG User Plane Function (UPF) or Access and Mobility Management Function (AMF) and the DU is to operate in a manner consistent with ORAN.

Example 17 includes one or more examples, wherein: the first network function is associated with a first tenant and the second network function is associated with a second tenant.

Example 18 includes one or more examples, and includes allocating a third region of the one or more memory regions to store third data reserved for access by a first 5G Core network User Plane Function (UPF), wherein the DU is to provide the third data and allocating a third region of the one or more memory regions to store fourth data reserved for access by a second 5G Core network UPF, wherein the DU is to provide the fourth data and the DU is shared among the first UPF and the second UPF.

Example 19 includes one or more examples, wherein: the first network function provides a service consistent with 3rd Generation Partnership Project (3GPP) fifth-generation wireless technology (5G) Release 15 (2018) or 3GPP NextG Core (5GC) in Release 16 (2020).

What is claimed is:

1. An apparatus comprising:
an input/output (I/O) interface;
circuitry coupled to the I/O interface, the circuitry configured to:
based on receipt of a first request, allocate a first region of one or more memory regions of a memory to store data reserved for access by a first network function, wherein the first network function comprises an Open Radio Access Network (ORAN) Control Unit (CU) of a radio access network (RAN) and wherein an ORAN Distributed Unit (DU) is to provide the data and
based on receipt of a second request, allocate a second region of one or more memory regions of the memory to store second data reserved for access by a second network function, wherein the second network function comprises a second ORAN CU of the RAN, the DU is to provide the second data, and the DU is shared among the first CU and the second CU.

2. The apparatus of claim 1, wherein:
the first request is to request isolation of a network slice for execution of the first network function.

3. The apparatus of claim 1, wherein:
the first network function comprises a NextG User Plane Function (UPF) or Access and Mobility Management Function (AMF).

4. The apparatus of claim 1, wherein:
the DU is to operate in a manner consistent with ORAN.

5. The apparatus of claim 1, wherein:
the first network function is associated with a first tenant and
the second network function is associated with a second tenant.

6. The apparatus of claim 1, wherein:
the circuitry is configured to:
based on receipt of a third request, allocate a third region of the one or more memory regions to store third data reserved for access by a first 5G Core network User Plane Function (UPF), wherein the DU is to provide the third data.

7. The apparatus of claim 6, wherein:
the circuitry is configured to:
based on receipt of a fourth request, allocate a third region of the one or more memory regions to store fourth data reserved for access by a second 5G Core network UPF, wherein the DU is to provide the fourth data and the DU is shared among the first UPF and the second UPF.

8. The apparatus of claim 1, wherein:
the first network function is to provide a service consistent with 3rd Generation Partnership Project (3GPP) fifth-generation wireless technology (5G) Release 15 (2018) or 3GPP NextG Core (5GC) in Release 16 (2020).

9. At least one machine readable medium comprising a plurality of instructions that in response to being executed by a processor, cause the processor to:
issue a first request to allocate a first region of one or more memory regions of the memory to store data reserved for access by a first network function, wherein the first network function comprises an Open Radio Access Network (ORAN) Control Unit (CU) of a radio access network (RAN) and wherein an ORAN Distributed Unit (DU) is to provide the data and
issue a second request to allocate a second region of one or more memory regions of the memory to store second data reserved for access by a second network function, wherein the second network function comprises a second ORAN CU of the RAN, the DU is to provide the second data, and the DU is shared among the first CU and the second CU.

10. The machine readable medium of claim 9, wherein:
the first request is to request isolation of a network slice for execution of the first network function.

11. The machine readable medium of claim 9, wherein:
the first network function comprises a NextG User Plane Function (UPF) or Access and Mobility Management Function (AMF) and
the DU is to operate in a manner consistent with ORAN.

12. The machine readable medium of claim 9, wherein:
the first network function is associated with a first tenant and
the second network function is associated with a second tenant.

13. The machine readable medium of claim 9, comprising a plurality of instructions that in response to being executed by a processor, cause the processor to:
based on receipt of a third request, allocate a third region of the one or more memory regions to store third data reserved for access by a first 5G Core network User Plane Function (UPF), wherein the DU is to provide the third data and
based on receipt of a fourth request, allocate a third region of the one or more memory regions to store fourth data reserved for access by a second 5G Core network UPF, wherein the DU is to provide the fourth data and the DU is shared among the first UPF and the second UPF.

14. The machine readable medium of claim 9, wherein:
the first network function is to provide a service consistent with 3rd Generation Partnership Project (3GPP) fifth-generation wireless technology (5G) Release 15 (2018) or 3GPP NextG Core (5GC) in Release 16 (2020).

15. A method comprising:
reserving a first region of one or more memory regions of the memory to store data from an Open Radio Access Network (ORAN) Distributed Unit (DU) for access by a first network function, wherein the first network function comprises an ORAN Control Unit (CU) of a radio access network (RAN) and
reserving a second region of one or more memory regions of the memory to store second data from the ORAN DU for access by a second network function, wherein the second network function comprises a second ORAN CU of the RAN and wherein the DU is shared among the first CU and the second CU.

16. The method of claim 15, wherein:
the first network function comprises a NextG User Plane Function (UPF) or Access and Mobility Management Function (AMF) and
the DU is to operate in a manner consistent with ORAN.

17. The method of claim 15, wherein:
the first network function is associated with a first tenant and
the second network function is associated with a second tenant.

18. The method of claim 15, comprising:
allocating a third region of the one or more memory regions to store third data reserved for access by a first 5G Core network User Plane Function (UPF), wherein the DU is to provide the third data and
allocating a third region of the one or more memory regions to store fourth data reserved for access by a second 5G Core network UPF, wherein the DU is to provide the fourth data and the DU is shared among the first UPF and the second UPF.

19. The method of claim 15, wherein:
the first network function provides a service consistent with 3rd Generation Partnership Project (3GPP) fifth-generation wireless technology (5G) Release 15 (2018) or 3GPP NextG Core (5GC) in Release 16 (2020).
